(19) United States
(12) Patent Application Publication
(10) Pub. No.: US 2025/0254681 A1
(43) Pub. Date: Aug. 7, 2025

(54) ENHANCED MANAGEMENT OF PERIODIC UPLINK DELAY SENSITIVE DATA TRAFFIC

(71) Applicant: Dell Products, L.P., Round Rock, TX (US)

(72) Inventor: Hemant Kumar Bhawarlal Jain, Bangalore (IN)

(21) Appl. No.: 18/433,112

(22) Filed: Feb. 5, 2024

(51) Int. Cl. H04W 72/1268; H04W 72/232; H04W 72/542

(52) U.S. Cl. CPC H04W 72/1268; H04W 72/232; H04W 72/542

(57) ABSTRACT

Enhanced communication of uplink data associated with a device, with reduced uplink delay and reduced discarding of data packets, can be performed and managed. Base station can employ communication manager component (CMC) that can receive, from the device, uplink data packet delay information associated with communication of first uplink data packet from device to base station. Device can determine uplink data pack delay based on difference between a time the uplink data packet is generated and a time the uplink data packet is communicated in accordance with uplink grant. CMC can determine second time of second uplink grant for communication of second uplink data packet from device to base station, based on analysis of uplink data packet delay information, first time of first uplink grant for communication of first uplink data packet, uplink grant time period, and/or jitter information relating to jitter associated with communication of uplink data packets.

### BACKGROUND

A communication network can comprise a group of base stations that can be associated with a core network to facilitate wireless communication of data by communication devices connected to one or more of the base stations of the communication network. For instance, a communication device can communicate data to a base station via an uplink (e.g., wireless uplink) communication connection (e.g., where the data can be forwarded by the base station to the core network or other part of the communication network, and/or to another communication device associated therewith), and the base station can download data (e.g., data originally sent from another communication device, or data originating in the core network or other part of the communication network) to the communication device via a downlink (e.g., wireless downlink) communication connection.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise receiving, by a system comprising a processor, from a device, uplink data packet delay information associated with a first communication of a first uplink data packet from the device to a base station. The method also can include: based at least in part on the uplink data packet delay information, determining, by the system, a time associated with an uplink grant for a second communication of a second uplink data packet from the device to the base station.

In certain embodiments, the disclosed subject matter can comprise a system that can comprise a memory that can store computer executable components, and a processor that can execute computer executable components stored in the memory. The computer executable components can comprise a distributed unit that can receive, from user equipment, uplink data delay information associated with a first transmission of first uplink data from the user equipment to a base station. The computer executable components also can comprise a communication manager component that, based at least in part on analysis of the uplink data delay information, can determine a time of an uplink grant for a second transmission of second uplink data from the user equipment to the base station.

In still other embodiments, the disclosed subject matter can comprise a non-transitory machine-readable medium, comprising executable instructions that, when executed by a processor, can facilitate performance of operations. The operations can comprise receiving, from a device, uplink data packet delay information associated with a first communication of a first uplink data packet from the device to network equipment. The operations also can comprise: based at least in part on the uplink data packet delay information, determining a time slot of a frame associated with an uplink grant for a second communication of a second uplink data packet from the device to the network equipment.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform communication of uplink data associated with a device, with reduced uplink data packet delay and reduced discarding of uplink data packets with regard to hybrid automatic repeat request (HARQ) retransmission, in accordance with various aspects and embodiments of the disclosed subject matter.

FIG. 2 depicts a diagram of an example configured grant for periodic communication of uplink data, in accordance with aspects and embodiments of the disclosed subject matter.

FIG. 3 depicts a diagram of an example periodic uplink grant for periodic communication of uplink data, in accordance with various aspects and embodiments of the disclosed subject matter.

FIG. 4 presents a diagram of an example HARQ retransmission scenario where uplink transmission delay can result in undesirable discarding of an uplink data packet, in accordance with various aspects and embodiments of the disclosed subject matter.

FIG. 5 illustrates a block diagram of a base station, in accordance with various aspects and embodiments of the disclosed subject matter, in accordance with various aspects and embodiments of the disclosed subject matter.

FIG. 6 depicts a block diagram of a device, in accordance with various aspects and embodiments of the disclosed subject matter.

FIG. 7 depicts a non-limiting example uplink data packet delay format that can indicate or specify an amount of time that an uplink data packet was delayed in transmission from the device to the base station, in accordance with various aspects and embodiments of the disclosed subject matter.

FIG. 8 depicts a diagram of non-limiting example frames that can be utilized to communicate uplink data packets from the device to the base station utilizing periodic uplink grants, in accordance with various aspects and embodiments of the disclosed subject matter.

FIG. 9 illustrates a diagram of non-limiting example frames that can be utilized to communicate uplink data packets from the device to the base station utilizing a configured grant, in accordance with various aspects and embodiments of the disclosed subject matter.

FIG. 10 depicts a diagram of an example HARQ retransmission scenario that can illustrate an instance where the packet delay budget for HARQ retransmission of an uplink data packet has been adjusted to account for and mitigate uplink data packet delay to facilitate prioritizing HARQ retransmission of the uplink data packet and mitigate undesirable discarding of uplink data packets with regard to HARQ retransmission, in accordance with various aspects and embodiments of the disclosed subject matter.

FIG. 11 depicts a block diagram of an example device that can be operable to engage in a system architecture that facilitates wireless communications according to one or more embodiments described herein.

FIG. 12 illustrates a flow chart of an example method that can desirably manage and perform communication of uplink data associated with a device, with reduced uplink data packet delay, in accordance with various aspects and embodiments of the disclosed subject matter.

FIGS. 13 and 14 depict a flow chart of another example method that can desirably manage and perform communication of uplink data associated with a device, with reduced uplink data packet delay, in accordance with various aspects and embodiments of the disclosed subject matter.

FIG. 15 illustrates a flow chart of an example method that can desirably manage and perform communication of uplink data associated with a device, with reduced discarding of uplink data packets with regard to HARQ retransmission, in accordance with various aspects and embodiments of the disclosed subject matter.

FIG. 16 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to managing data traffic, including periodic data traffic, being communicated in communication networks (e.g., fifth generation (5G) or other new radio (NR) communication networks. A communication network can comprise a group of base stations that can be associated with a core network to facilitate wireless communication of data by communication devices connected to one or more of the base stations of the communication network. For instance, a communication device can communicate data to a base station via an uplink (e.g., wireless uplink) communication connection (e.g., where the data can be forwarded by the base station to the core network or other part of the communication network, and/or to another communication device associated therewith), and the base station can download data (e.g., data originally sent from another communication device, or data originating in the communication network) to the communication device via a downlink (e.g., wireless downlink) communication connection.

Communication networks can support various types of services. Some services can generate and communicate data traffic in a periodic manner. A communication network (e.g., a base station of the communication network) can utilize periodic resource allocation to facilitate communication of the periodic data traffic of such services via the communication network. With regard to some services and/or some data traffic of some services, the periodic data traffic can be delay sensitive (e.g., delay critical or otherwise delay sensitive) data traffic where it can be desirable to reduce or minimize delay associated with communication of such periodic data traffic. For instance, some services, such as services relating to factory automation, process automation, autonomous or semi-autonomous vehicles (e.g., vehicle-to-everything (V2X)-related services), law enforcement, emergency, military, the smart grid, or other service types can employ communication of delay sensitive data traffic, including delay sensitive periodic data traffic.

Configured grants and periodic uplink grants can be employed to facilitate communication of periodic uplink data traffic. For instance, to handle the periodic uplink data traffic pattern, the base station (e.g., a distributed unit (DU) of the base station) can provide periodic uplink grants by enabling or activating a configured grant or performing periodic uplink scheduling with periodicity of “uplink data periodicity.” With a configured grant, the device (e.g., user equipment (UE)) can send uplink data periodically without waiting for downlink control information (DCI) for uplink. The periodicity of the configured grant and communication of the uplink data can be configured via radio resource control (RRC) signaling (e.g., by the base station to the device), for example. The configured grant periodicity can be equal to a desired uplink data periodicity (e.g., associated with or required by the service being employed). The time and frequency domain allocation can be reserved by the base station (e.g., the DU of the base station) and the base station can provide information relating to the time and frequency domain allocation to the device via DCI when the configured grant is being activated. With a periodic uplink grant, the base station (e.g., the DU of the base station) can provide an uplink grant periodically by sending time and frequency domain allocation, via DCI, to the device. Once the uplink grant is received by the device, the device can send the uplink data. The uplink grant periodicity can be set to the uplink data periodicity (e.g., associated with the service).

There can be a number of problems or deficiencies with regard to the existing configured grant techniques and periodic uplink grant techniques. For instance, when existing uplink grant techniques are employed, the base station typically does not know when the device is generating the uplink data (e.g., uplink data packet(s)) that is to be periodically communicated. As a result, the base station often may configure a configured grant or schedule a periodic uplink grant for a time slot that may be a significant amount of time after the device has generated the uplink data and inserted the uplink data in its buffer component (e.g., medium access control (MAC) buffer) to wait for the uplink grant time slot. This can result in an undesirable (e.g., unwanted, inefficient, performance degrading, or otherwise undesirable) amount of uplink data packet delay between the time of generation of the uplink data packet by the device and the communication of the uplink data packet at the time slot of the uplink grant, which can undesirably (e.g., unwantedly or inefficiently) degrade or negatively impact performance of the service and/or the device, or interrupt performance of the service.

Another problem or deficiency with regard to existing uplink communication techniques can be undesirable discarding of uplink data packets for hybrid automatic repeat request (HARQ) retransmission due to uplink data packet delay (e.g., uplink transmission delay). There can be a packet delay budget of a defined amount of time for HARQ retransmission of an uplink data packet. If the uplink transmission delay for the first HARQ retransmission is too large, it may cause the packet delay budget to be exceeded without the opportunity for the first HARQ retransmission by the device, which can result in an undesirable (e.g., unwanted or inefficient) discarding of the uplink data packet. This can result in an undesirable degradation of performance of the service and/or the device, or interruption of performance of the service.

The disclosed subject matter can address and overcome these and other deficiencies of existing techniques with regard to configured grants, periodic uplink grants, and HARQ retransmissions.

To that end, techniques that can desirably (e.g., suitably, reliably, efficiently, enhancedly, and/or optimally) manage and perform communication of uplink data associated with a device, with reduced uplink data packet delay and reduced discarding of uplink data packets with regard to HARQ retransmission, are presented. A system can comprise a communication network that can comprise a base station that can be associated with (e.g., communicatively connected to) a core network and one or more devices (e.g., communication device, such as a mobile phone, a computer, an electronic pad or tablet, or other type of communication device). The base station (e.g., a DU of the base station) can employ a communication manager component (CMC) that can receive, from the device, uplink data packet delay information associated with communication (e.g., wireless communication) of a first uplink data packet from the device to the base station, wherein the uplink data packet delay information can indicate or specify an uplink data packet delay (e.g., an amount of uplink data packet delay) associated with the communication of the first uplink data packet. In some embodiments, the device (e.g., a device CMC) can determine the uplink data pack delay based at least in part on a difference between a time the uplink data packet is generated and a time that the uplink data packet is communicated from the device to the base station in accordance with a first uplink grant (e.g., first periodic uplink grant or first configured grant).

To facilitate reducing uplink data packet delay, the CMC can determine a second time of a second uplink grant (e.g., second periodic uplink grant or second configured grant) for communication of a second uplink data packet from the device to the base station, based at least in part on the results of an analysis of the uplink data packet delay information, a first time of the first uplink grant for communication of the first uplink data packet, an uplink grant time period, and/or jitter information relating to a defined threshold amount of jitter associated with communication of uplink data packets. For instance, if the CMC determines that the amount of uplink data packet delay is greater than the defined threshold amount of jitter, the CMC can determine that a modification (e.g., adjustment or change) is to be made to the uplink grant(s) (e.g., the second uplink grant and/or subsequent uplink grants) to facilitate reducing uplink data packet delay. Accordingly, the CMC can determine the second time of the second uplink grant as a function of the amount of uplink data packet delay, the first time of the first uplink grant, the uplink grant time period, and the defined threshold amount of jitter (e.g., with regard to a periodic uplink grant, the second time of second uplink grant (e.g., second periodic uplink grant) can equal the first time of first uplink grant plus the uplink grant time period minus a net total of the amount of uplink data packet delay minus the defined threshold amount of jitter; or, with regard to a configured grant, the configured grant can be reconfigured to have the second time of second uplink grant (e.g., second configured grant time slot) be equal the first time of first uplink grant (e.g., first configured grant time slot) plus the uplink grant time period minus a net total of the amount of uplink data packet delay minus the defined threshold amount of jitter). This modification of the time of the uplink grant can desirably (e.g., suitably, reliably, efficiently, enhancedly, and/or optimally) mitigate (e.g., reduce or minimize) the amount of uplink data packet delay by placing (e.g., temporally placing) the uplink grant (e.g., second uplink grant) for the uplink data packet (e.g., second uplink data packet) closer to the time the data packet was generated or buffered by the device as compared to the previous uplink grant (e.g., first uplink grant).

If, instead, the CMC determines that the amount of uplink data packet delay is less than or equal to the defined threshold amount of jitter, the CMC can determine the second time of the second uplink grant as a function of the first time of the first uplink grant and the uplink grant time period (e.g., with regard to a periodic uplink grant, the second time of second uplink grant (e.g., second periodic uplink grant) can equal the first time of first uplink grant plus the uplink grant time period; or, with regard to a configured grant, the second time of second uplink grant (e.g., second configured grant time slot) can equal the first time of first uplink grant (e.g., first configured grant time slot) plus the uplink grant time period).

In some embodiments, with regard to a periodic uplink grant, if the device CMC of the device determines that the amount of uplink data packet delay for an uplink transmission has not changed as compared to a previous uplink transmission, the device CMC does not have to communicate uplink data packet delay information to the base station. In such instance, if the CMC of the base station does not receive uplink data packet delay information from the device in connection with an uplink transmission, the CMC can assume that the amount of uplink data packet delay has not changed as compared to the previous uplink transmission. As a result, the CMC can determine the time of a next periodic uplink grant as a function of the time of the most recent periodic uplink grant and the uplink grant time period (e.g., the time of next periodic uplink grant can equal the time of most recent periodic uplink grant plus the uplink grant time period).

In certain embodiments, the CMC can desirably (e.g., suitably, reliably, efficiently, enhancedly, and/or optimally) mitigate (e.g., reduce or minimize) the discarding of uplink data packets with regard to HARQ retransmissions due to uplink transmission delay. For instance, the CMC can monitor uplink transmission of data packets associated with the device (e.g., from the device to the base station) to facilitate determining whether a cyclic redundancy check (CRC) failure is detected. If the CMC detects a CRC failure, the CMC can determine an available packet delay budget for HARQ retransmission of an uplink data packet as a function of the packet delay budget for HARQ retransmission and the uplink data packet delay (e.g., the packet delay budget minus the uplink data packet delay), wherein the uplink data packet delay information can be received from the device, such as described herein. The CMC can prioritize HARQ retransmission of the uplink data packet based at least in part on (e.g., within) the available packet delay budget (e.g., a smallest value of the available packet delay budget). The prioritization of retransmission of the uplink data packet, based at least in part on the available packet delay budget, can ensure, facilitate ensuring, or at least attempt to and more desirably ensure, that HARQ retransmission can still be attempted with the packet delay budget. Such prioritization of retransmission of the uplink data packet, based at least in part on the available packet delay budget, can desirably mitigate discarding of uplink data packets with regard to HARQ retransmissions of data packets.

These and other aspects and embodiments of the disclosed subject matter will now be described with respect to the drawings.

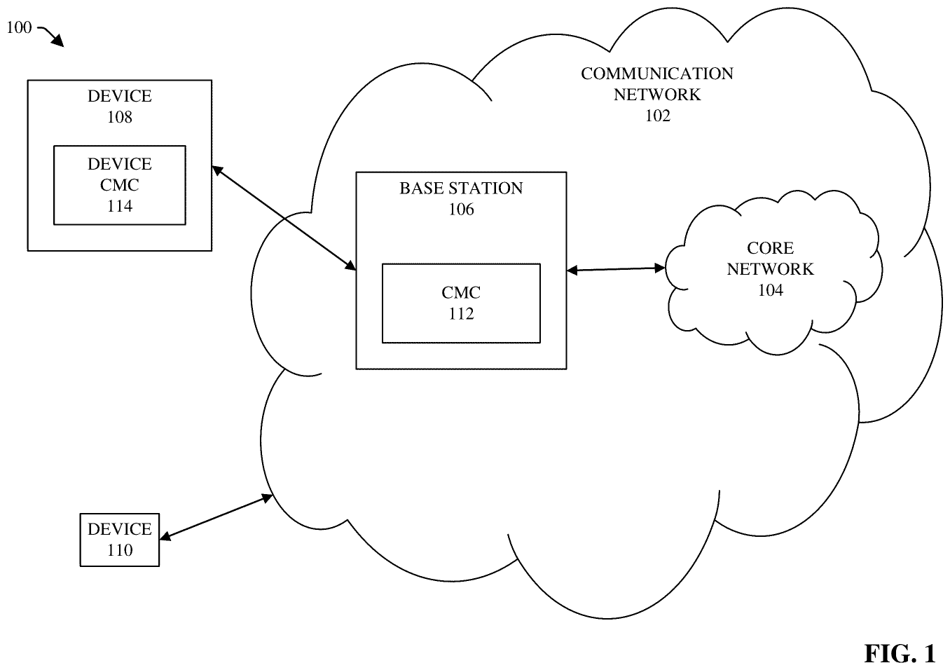

Referring now to the drawings, FIG. 1 illustrates a block diagram of a non-limiting example system 100 that can desirably (e.g., efficiently, reliably, suitably, enhancedly, or optimally) manage and perform communication of uplink data associated with a device, with reduced uplink data packet delay and reduced discarding of uplink data packets with regard to HARQ retransmission, in accordance with various aspects and embodiments of the disclosed subject matter. The system 100 can comprise a communication network 102 that can comprise a core network 104 and one or more base stations, including base station 106, that can be associated with (e.g., communicatively connected to) the core network 104. The core network 104 and the one or more base stations (e.g., base station 106) can facilitate (e.g., enable) wireless communication of data (e.g., voice or other audio data, video data, textual data, or other data) between devices (e.g., communication devices or UEs), such as devices associated with the core network 104, via the one or more base stations, and other devices associated with the core network 104 or, more generally, the communication network 102 (e.g., a device, such as a server or computer, can be connected to the communication network 102 via a wireline connection or via a network other than the core network 104).

The devices can comprise, for example, devices 108 and/or 110. A device (e.g., 108 and/or 110) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device. The device 108 and/or 110 can be associated with (e.g., communicatively connected to) the communication network 102 via a communication connection and channel, which can include a wireless or wireline communication connection and channel. For example, the device 108 can be associated with (e.g., communicatively connected to) the base station 106 of the communication network 102 via a wireless communication connection.

In accordance with various embodiments, the core network 104 can comprise various network components that can facilitate wireless communication of data. In some embodiments, the core network 104 can comprise various network nodes or functions (e.g., a user plane function (UPF) node, an access and mobility management function (AMF) node, and/or other network nodes or functions). For instance, a network node (e.g., UPF node) of the core network 104 can connect to or interface with the one or more base stations (e.g., base station 106), can be an interconnect point between the core network 104 and a data network, can provide or facilitate providing a protocol data unit (PDU) session anchor point for providing mobility associated with radio access technologies (RATs), can provide or facilitate providing data packet routing or forwarding, and/or can perform or manage other functions.

The communication network 102, more generally, or the core network 104 can comprise various other network equipment (e.g., routers, gateways, transceivers, switches, access points, radio access networks (RANs), or other devices) that facilitate (e.g., enable) communication of information between respective items of network equipment of the communication network 102, and/or communication of information between the one or more devices (e.g., devices 108 and/or 110) and the communication network 102. The communication network 102, including the core network 104, can provide or facilitate wireless or wireline communication connections and channels between the one or more devices (e.g., devices 108 and/or 110), and/or respectively associated services or application, and the communication network 102. For reasons of brevity or clarity, some of the various network equipment, components, functions, or devices of the communication network may not be explicitly shown.

The communication network 102 can support various types of services. Some services can generate and communicate at least some data traffic in a periodic manner. The communication network 102 (e.g., the base station 106 of the communication network 102) can utilize periodic resource allocation to facilitate communication of the periodic data traffic of such services via the communication network. With regard to some services and/or some data traffic of some services, the periodic data traffic can be delay sensitive (e.g., delay critical or otherwise delay sensitive) data traffic where it can be desirable (e.g., wanted, needed, suitable, optimal, or otherwise desirable) to reduce or minimize delay associated with communication of such periodic data traffic. For instance, some services, such as services relating to factory automation, process automation, autonomous or semi-autonomous vehicles (e.g., vehicle-to-everything (V2X)-related services), law enforcement, emergency, military, the smart grid, or other service types can employ communication of delay sensitive data traffic, including delay sensitive periodic data traffic, for which it can be desirable to reduce or minimize delay associated with communication of such periodic data traffic. V2X-related services or solutions can include, for example, vehicle-to-vehicle (V2V) services, solutions, or communications, vehicle-to-infrastructure (V2I) services, solutions, or communications, vehicle-to-pedestrian (V2P) services, solutions, or communications, vehicle-to-cloud (V2C) services, solutions, or communications, and/or other type of V2X service, solution, or communication.

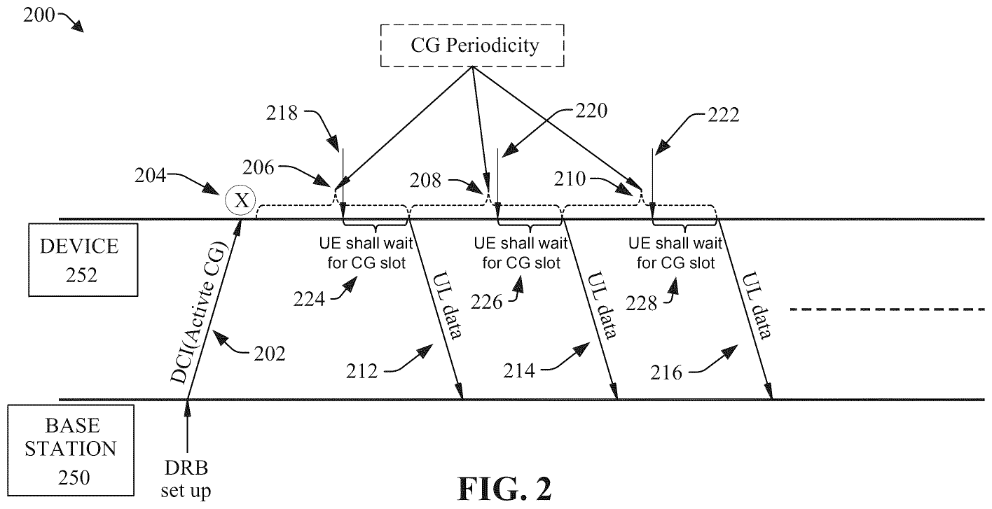

To handle the periodic uplink data traffic pattern associated with a service, the base station 106 (e.g., a DU, such as a gNB-DU, of the base station 106) can provide a periodic uplink grant either by enabling or activating a configured grant or by performing a periodic uplink grant (e.g., a periodic uplink scheduling) with a periodicity of an uplink data periodicity. Referring briefly to FIG. 2 (along with FIG. 1), FIG. 2 depicts a diagram of an example configured grant 200 for periodic communication of uplink data (e.g., associated with a service), in accordance with aspects and embodiments of the disclosed subject matter. To facilitate activating, initiating, or configuring the configured grant (CG), a base station 250 can communicate DCI (e.g., uplink DCI), comprising configuration or activation information for configuring or activating the configured grant (e.g., for uplink data transmission), to a device 252 (e.g., UE), as indicated at reference numeral 202. The communication of the DCI to the device 252 and/or the configuration or activation of the configured grant can be in connection with the setting up (e.g., establishing) of delay sensitive (e.g., delay critical or otherwise delay sensitive) data radio bearers (DRB) (e.g., associated with a service being employed by the device 252) by the base station 250. In response to receiving this DCI, the device 252 can activate and/or configure the configured grant, as indicated at reference numeral 204. The configured grant can have a configured grant periodicity that can be equal to the uplink (UL) data periodicity (e.g., associated with or specified by the service). In accordance with the configured grant periodicity, the respective times of the configured grant periods (e.g., the beginnings of the configured grant periods) can be, for example, as indicated at reference numerals 206, 208, and 210.

With a configured grant, once the configured grant is activated and/or configured, the device 252 can communicate uplink data periodically without having to wait for explicit uplink DCI from the base station 250, such as indicated at reference numerals 212, 214, and 216. The periodicity of the configured grant and communication of the uplink data can be configured via RRC signaling (e.g., by the base station 250 to the device 252), for example. The configured grant periodicity can be equal to a desired uplink data periodicity (e.g., associated with or required by the service being employed). The time and frequency domain allocation can be reserved by the base station 250 (e.g., the DU of the base station) and the base station 250 can provide information relating to the time and frequency domain allocation to the device 252 via DCI when the configured grant is being activated.

The device 252 may (e.g., during each configured grant period) generate uplink data associated with the service and store the uplink data (e.g., uplink data packets) in a buffer component (e.g., MAC buffer component) of the device 252, as indicated at reference numerals 218, 220, and 222, where the uplink data may wait in the buffer component until the time slot of the frame allocated for the configured grant is reached, at which time the uplink data packet can be sent from the buffer component of the device 252 to the base station 250 using the configured grant time slot, as indicated at reference numerals 224, 226, and 228. When existing techniques for configured grants are employed, there may be an undesirable (e.g., unwanted, unsuitable, unacceptable, or otherwise undesirable) amount of uplink data packet delay between the time that a data packet is generated and stored in the buffer component and the time that the data packet is communicated using the configured grant time slot, as indicated by the wait time between the time an uplink data packet being stored in the buffer component (e.g., as indicated at reference numerals 218, 220, and 222) and the time the uplink data packet is communicated from the buffer component of the device 252 to the base station 250 using the configured grant time slot (e.g., as indicated at reference numerals 224, 226, and 228).

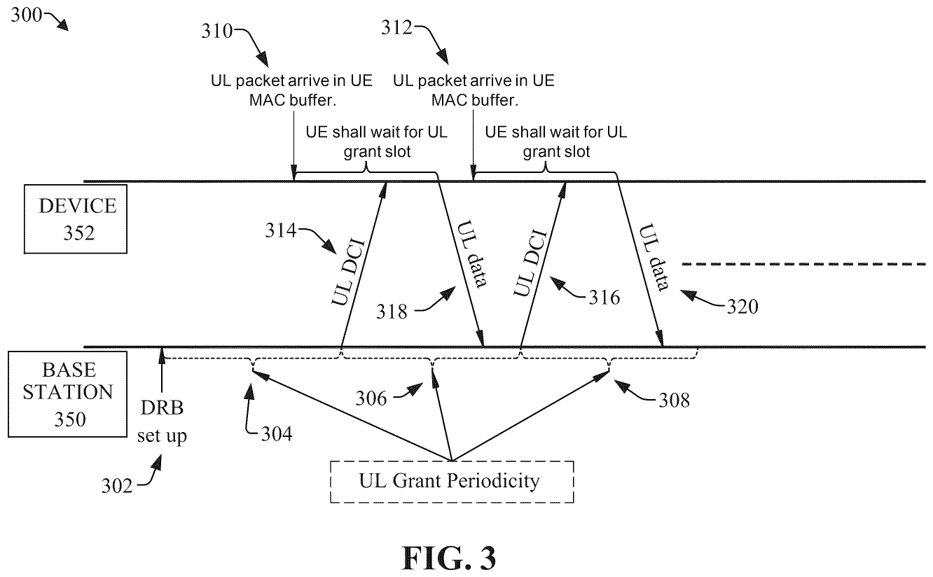

A similar uplink data packet delay issue can occur with regard to periodic uplink data packet transmissions as well. Turning briefly to FIG. 3 (along with FIG. 1), FIG. 3 depicts a diagram of an example periodic uplink grant 300 for periodic communication of uplink data (e.g., associated with a service), in accordance with various aspects and embodiments of the disclosed subject matter. With a periodic uplink grant, a base station 350 (e.g., the DU of the base station 350) can provide an uplink grant periodically to a device 352 by sending time and frequency domain allocation to the device 352 via DCI. In response to receiving the uplink grant, the device 352 can communicate the uplink data at the time of the uplink grant using the time slot corresponding to the time of the uplink grant. The uplink grant periodicity can be set to a desired uplink data periodicity (e.g., associated with or required by the service being employed).

For instance, as indicated at reference numeral 302, the base station 350 can set up (e.g., establish) a delay sensitive DRB (e.g., associated with a service being employed by the device 352). In accordance with the uplink grant periodicity, the respective times of the uplink grant periods (e.g., the beginnings of the periodic uplink grant periods) can be, for example, as indicated at reference numerals 304, 306, and 308.

The device 352 may (e.g., during each periodic uplink grant period) generate uplink data associated with the service and store the uplink data (e.g., uplink data packets) in the buffer component of the device 352, as indicated at reference numerals 310 and 312, where the uplink data may wait in the buffer component until the time of the uplink grant, such as described herein. During each of the respective uplink grant periods, the base station 350 can communicate DCI (e.g., uplink DCI), comprising uplink grant information, to the device 352, such as indicated at reference numerals 314 and 316. The respective uplink grant information can indicate the respective times (e.g., respective time slots during respective frames associated with respective SFNs) that the respective uplink data can be sent by the device 352 to the base station 350.

In accordance with the respective periodic uplink grants, at the respective times (e.g., time slots) of the respective uplink grants, the device 352 can communicate the respective uplink data from the buffer component of the device 352 to the base station 350 using the respective time slots of the respective uplink grants, as indicated at reference numerals 318 and 320. When existing techniques for periodic uplink grants are employed, there may be an undesirable (e.g., unwanted, unsuitable, unacceptable, or otherwise undesirable) amount of uplink data packet delay between the time that a data packet is generated and stored in the buffer component of the device 108 and the time that the data packet is communicated using the periodic uplink grant time slot, as indicated by the wait time between the time an uplink data packet is stored in the buffer component (e.g., as indicated at reference numerals 310 and 312) and the time the uplink data packet is communicated from the buffer component of the device 352 to the base station 350 using the uplink grant time slot (e.g., as indicated at reference numerals 318 and 320).

It can be desirable (e.g., wanted, suitable, or optimal) to mitigate (e.g., reduce or minimize) such undesirable amount of uplink data packet delay associated with periodic uplink grants and configured grants.

Another issue that can arise with uplink data transmissions is with regard to HARQ retransmission of uplink data packets. For instance, if there is a relatively large uplink transmission delay with regard to HARQ retransmission of an uplink data packet, there can be undesirable (e.g., unwanted, unnecessary, inefficient, or unsuitable) discarding of uplink data packets with regard to HARQ retransmission.

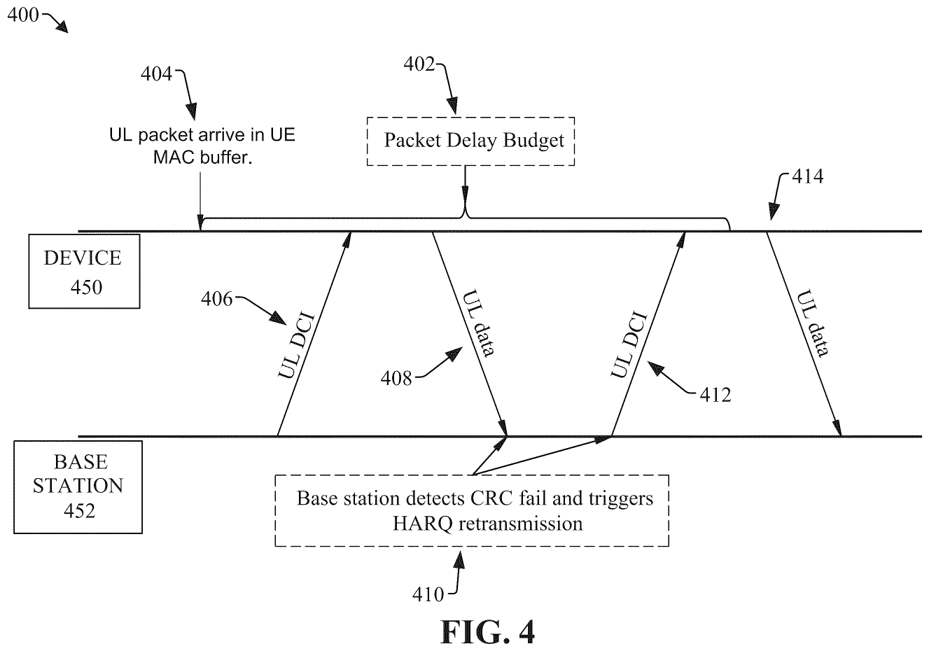

Turning briefly to FIG. 4, FIG. 4 presents a diagram of an example HARQ retransmission scenario 400 where uplink transmission delay can result in undesirable discarding of an uplink data packet, in accordance with various aspects and embodiments of the disclosed subject matter. With regard to HARQ retransmission, there can be a packet delay budget 402 of a defined amount of time during which there can be a HARQ retransmission of an uplink data packet. A device 450 can generate uplink data associated with the service and store the uplink data (e.g., uplink data packet) in the buffer component of the device 450, as indicated at reference numeral 404, where the uplink data may wait in the buffer component until the time of the uplink grant, such as described herein. Employing existing HARQ techniques, the packet delay budget 402 can begin at or at least near the time the uplink data packet is stored in the buffer component of the device 450.

A base station 452 can communicate DCI, comprising uplink grant information, to the device 450, such as indicated at reference numeral 406. The uplink grant information can indicate the time (e.g., time slot during a frame associated with an SFN) that the uplink data packet can be transmitted by the device 450 to the base station 452. The device 450 can transmit the uplink data packet to, or at least towards, the base station 452 at the time of the uplink grant, in accordance with the uplink grant, as indicated at reference numeral 408. In connection with transmission of the uplink data packet, the base station 452 can detect a CRC failure and can trigger (e.g., initiate) a HARQ retransmission to request that the device 450 retransmit the uplink data packet.

As indicated at reference numeral 410, in connection with the HARQ retransmission request, the base station 452 can communicate DCI, comprising uplink grant information, to the device 450, wherein such uplink grant information can indicate the time (e.g., another time slot during another frame associated with another SFN) that the HARQ retransmission of the uplink data packet can be performed by the device 450 to communicate the retransmitted uplink data packet to the base station 452. In this example HARQ retransmission scenario 400, the device 450 can receive this DCI within the packet delay budget 402, however, due in part to the undesirable uplink transmission delay associated with the initial transmission of the uplink data packet, the time of the uplink grant for the HARQ retransmission can be outside of the packet delay budget 402 (e.g., can be after the packet delay budget 402 has expired), as indicated at reference numeral 412. As a result, the uplink data packet undesirably can be discarded prior to HARQ retransmission due to the packet delay budget 402 being exceeded without the device 450 having the opportunity to perform the HARQ retransmission of the uplink data packet while within the packet delay budget 402.

As indicated, in a case where the uplink grant time slot is beyond the packet delay budget, the base station (e.g., the DU scheduler of the base station) may drop or discard the HARQ retransmission of an uplink data packet. This can be done in this way as the packet delay budget would be exceeded, and hence, there may be nothing gained by performing HARQ retransmission.

It can be desirable (e.g., wanted, suitable, or optimal) to mitigate (e.g., reduce or minimize) such undesirable discarding of uplink data packets with regard to HARQ retransmission that can be due in part to an undesirable amount of uplink data packet delay associated with uplink grants for transmission of uplink data.

The disclosed subject matter (e.g., the system 100, other systems, components, methods, and techniques described herein) can overcome these and other problems (e.g., deficiencies, inefficiencies, or other problems) of existing techniques, systems, and methods for transmission of uplink data using configured grants or periodic uplink grants and for HARQ retransmission of uplink data packets. To that end, in accordance with various embodiments, the base station 106 can comprise a communication manager component (CMC) 112 that can desirably (e.g., suitably, reliably, efficiently, enhancedly, or optimally) manage configured grants and/or periodic uplink grants for transmission of uplink data, and HARQ retransmission of uplink data packets, including mitigating (e.g., reducing or minimizing) undesirable uplink data packet delay (e.g., undesirable amount of uplink data packet delay) associated with configured grants, periodic uplink grants, or HARQ retransmission, such as described herein. In accordance with various embodiments, a device (e.g., the device 108) can comprise a device CMC 114 that, from the device side, can desirably (e.g., suitably, efficiently, enhancedly, or optimally) manage transmission of uplink data using configured grants or periodic uplink grants, and HARQ retransmission of uplink data packets, wherein undesirable uplink data packet delay can be mitigated, such as described herein.

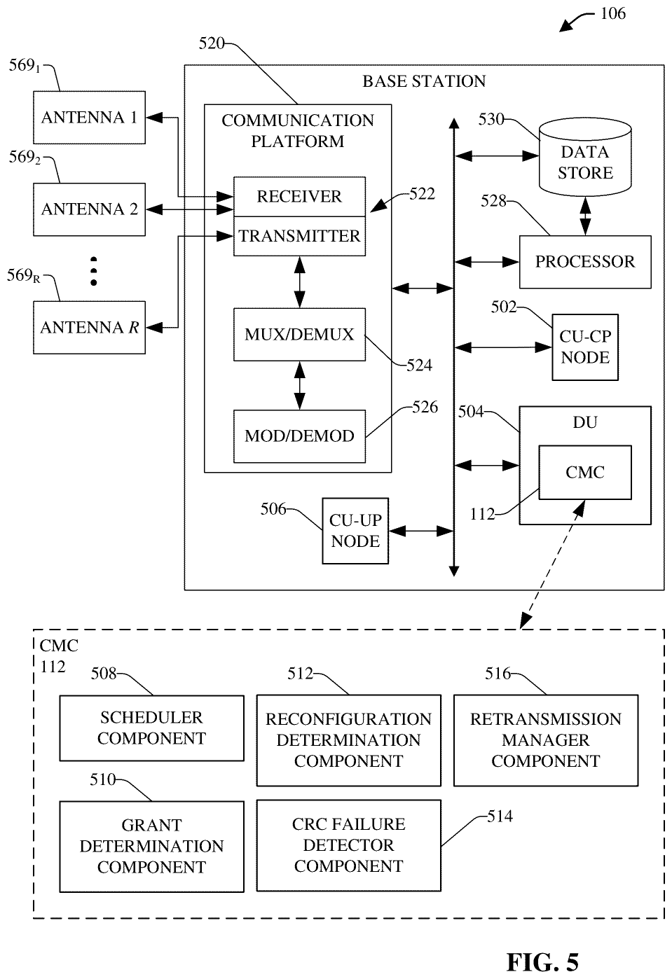

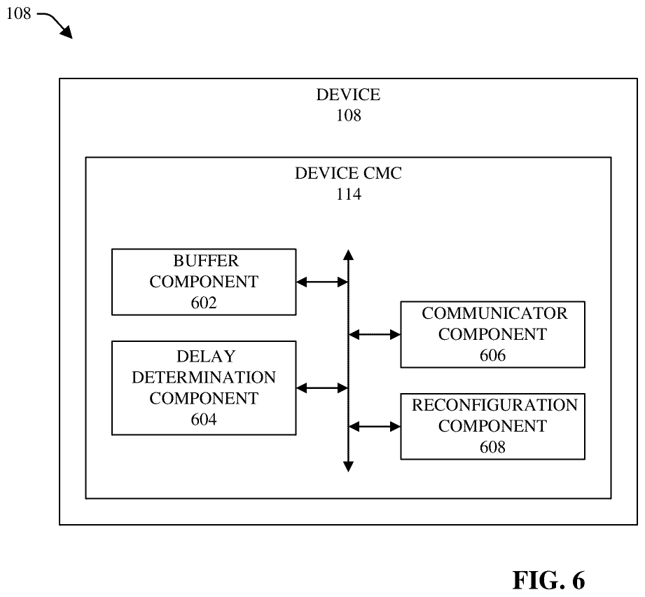

Referring to FIGS. 5 and 6 (along with FIG. 1), FIG. 5 illustrates a block diagram of the base station 106, and FIG. 6 depicts a block diagram of the device 108, in accordance with various aspects and embodiments of the disclosed subject matter. The base station 106 can comprise the CMC 112. The device 108 can comprise the device CMC 114.

In some embodiments, the base station 106 can be a 5G or other NR base station (e.g., gNB or other NR-type or xG base station, wherein x can be a number greater than 5). In other embodiments, the base station 106 can be a 4G or LTE base station, or some other type of base station (e.g., other type of access point).

With regard to a 5G or other NR base station, the base station 106 can comprise a central unit (CU)-control plane (CP) node 502 (e.g., a gNB or other NR-NB CU-CP node), one or more DUs (e.g., a gNB or other NR-NB DUs), including DU 504, a desired number of CU-user plane (UP) nodes (e.g., a gNB or other NR-NB CU-UP nodes), including CU-UP node 506, and/or other network equipment. The CU-CP node 502 can be associated or interfaced with the DUs (e.g., DU 504) via an interface (e.g., F1-C interface) or connection. The CU-CP node 502 can be associated or interfaced with the CU-UP nodes (e.g., CU-UP node 506) via an interface (e.g., E1 interface) or connection. The one or more CU-UP nodes (e.g., CU-UP node 506) can be associated or interfaced with the one or more DUs (e.g., DU 504) via an interface (e.g., F1-U interface) or connection.

A DU (e.g., DU 504) can provide support for lower layers of the protocol stack. For instance, a DU (e.g., DU 504) can be a logical node that can host or handle baseband (e.g., physical layer (PHY)) and L2 (e.g., MAC and radio link control (RLC) layer) functionality associated with the base station 106. A CU-UP node (e.g., CU-UP node 506) can be a logical node that can host or handle data traffic between the core network 104 (e.g., 5G or other NR or xG core network) and the DU(s) (e.g., DU 504) to which the particular CU-UP is connected. The CU-CP node 502 can be a logical node that can host or handle L3 (e.g., radio resource control (RRC) and packet data convergence protocol (PDCP) layer) control plane functionality associated with the base station 106.

In some embodiments, the device 108 can be connected to the base station 106, via the DU 504, wherein the CU-UP node 506 and the DU 504 can be serving the device 108 by performing or facilitating performing downlink data transfers of downlink data to the device 108 from a data source (e.g., a service and/or another device, such as device 110, or a network component of the communication network 102 or core network 104 (e.g., via the UPF node)), and uplink data transfers of uplink data from the device 108 to a desired destination (e.g., the data source) via the base station 106. In certain embodiments, the DU 504 can comprise the CMC 112 (as depicted), although, in other embodiments, the CMC 112 can be located outside of the DU 504 and can be associated with (e.g., communicatively connected to) the DU 504.

With regard to periodic uplink grants and configured grants, a significant root cause for undesired uplink data packet delay can be that, when using existing techniques, a base station (e.g., a DU 504 of the base station) does not know when the periodic uplink data packets are being generated by a device. Without this information relating to uplink data packet delay, the base station cannot optimize the uplink scheduling to minimize uplink data packet delay.

As an example of uplink data packet delay associated with a periodic uplink transmission, for a service (e.g., a delay sensitive or delay critical service) that generates an uplink data packet every 20 milliseconds (ms), if it is assumed that a time slot duration is 0.5 ms, a first uplink data packet can be generated by the device at, for instance, SFN 0 slot 0, and the next uplink data packet can be generated at SFN 2 slot, and so on. In this example, the base station (e.g., the DU of the base station) can schedule an uplink grant every 40 time slots. The base station can provide the first uplink grant for SFN 0 slot 15. Since the first uplink grant for SFN 0 slot 15, the first uplink data packet delay can be 15 slots (e.g., SFN 0 slot 15−SFN 0 slot 0=15 slots).

It can be desirable to mitigate this uplink data packet delay for services, particularly delay sensitive services (e.g., delay critical services), as mitigating such delay can enhance the performance, efficiency, and reliability of such services. In accordance with various embodiments, to mitigate the uplink data packet delay, the base station (e.g., DU 504 of base station 106, employing the CMC 112) can schedule a time slot of an uplink grant for an uplink data packet as close to a time slot when the uplink data packet was generated or buffered by the device 108. To facilitate achieving this mitigation of uplink data packet delay, the device 108 (e.g., the device CMC 114 of the device 108) can provide (e.g., communicate) uplink data packet delay information relating to (e.g., indicating or specifying) uplink data packet delay when the device 108 transmits the uplink data packet to the base station 106, such as described herein. Based at least in part on the uplink data packet delay information received from (e.g., reported by) the device 108, the CMC 112 can determine (e.g., calculate) the time when the next uplink grant for the next uplink data packet is to be scheduled such that the uplink data packet delay can be mitigated (e.g., reduced or minimized) for transmission of the next uplink data packet (and/or other future uplink data packets) by the device 108 to the base station 106, such as described herein.

In some embodiments, the device 108 can be utilizing a service (e.g., a delay sensitive or critical service, or other type of service), and periodically can generate uplink data packets and communicate those uplink data packets to the service (e.g., a device (e.g., device 110) associated with the service) or another desired destination (e.g., another device or component). When an uplink data packet is generated by the device 108, the device CMC 114 can store the uplink data packet in a buffer component 602, which can comprise storage locations (e.g., buffer memory locations) in which uplink data packets can be stored (e.g., temporarily stored until ready to be transmitted). The buffer component 602 can comprise volatile or non-volatile memory to facilitate storing or buffering the uplink data and/or other data (e.g., downlink data or other data), such as described herein.

In connection with an uplink data packet to be transmitted from the device 108 to the base station 106, the CMC 112, employing a scheduler component 508, can schedule an uplink grant (e.g., periodic uplink grant, or configured grant) for transmission of the uplink data packet from the device 108 to the base station 106, and can communicate DCI, comprising uplink grant information, to the device 108, wherein the uplink grant information can indicate or specify the time (e.g., the time slot of a frame) that the device 108 can transmit the uplink data packet to the base station 106.

The device 108 can receive the uplink grant information. The device CMC 114, employing a delay determination component 604, can determine (e.g., calculate) an uplink data packet delay associated with transmission of that uplink data packet based at least in on (e.g., as a function of) the time (e.g., generation time) that the uplink data packet was generated by the device 108 and the time (e.g., transmission time) that the uplink data packet is or will be sent, in accordance with the time (e.g., uplink grant time) of the uplink grant. For example, the delay determination component 604 can determine the uplink data packet delay as equal to the time when the uplink data packet was generated or received (e.g., generation time) by the device 108 minus the time when the uplink data packet is sent (e.g., transmission time or uplink grant time). While time of generation of the uplink data packet can be utilized by the device CMC 114 to facilitate determining the uplink data packet delay, in certain embodiments, the device CMC 114 can utilize the time (e.g., buffer time) that the uplink data packet is inserted and stored in the buffer component 602 to wait until the time of the uplink grant, or another time where the uplink data packet is ready and waiting for transmission from the device 108 to the base station 106. It is noted that the generation time of generation of the uplink data packet by the device 108 and the buffer time of inserting and storing (e.g., buffering) the uplink data packet in the buffer component 602 will occur at or very near (e.g., approximately) the same time, as typically, the device 108 can generate the uplink data packet and insert the uplink data packet into the buffer component 602 as the uplink data packet is output from generation.

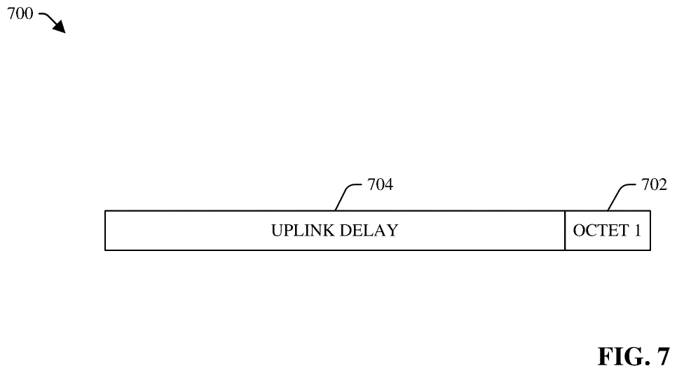

Referring briefly to FIG. 7 (along with FIGS. 1, 5, and 6), FIG. 7 depicts a non-limiting example uplink data packet delay format 700 (e.g., uplink delay MAC control element (CE) format) that can indicate or specify an amount of time that an uplink data packet was delayed in transmission from the device 108 to the base station 106, in accordance with various aspects and embodiments of the disclosed subject matter. The example uplink data packet delay format 700 can be or can comprise an octet (e.g., Octet 1) 702 where the uplink data packet delay information associated with the uplink data packet can be stored or represented in an uplink delay field 704 that can comprise the bits (e.g., eight bits) of the octet 702 (e.g., the bits of the octet can be set to or generated to have values that can represent the amount of the uplink data packet delay associated with the uplink data packet). The device CMC 114 (e.g., the delay determination component 604 of the device CMC 114) can generate the uplink data packet delay information, in accordance with the uplink data packet delay format 700, based at least in part on, and to represent, indicate, or specify, the amount of uplink data packet delay associated with the uplink data packet. The uplink data packet delay format 700 can indicate or specify the amount of time (e.g., the number of time slots) that an uplink data packet was delayed in transmission (e.g., was waiting in the buffer component 602 for transmission) from the device 108 to the base station 106.

It is to be appreciated and understood that the example uplink data packet delay format 700 is merely one example format that the disclosed subject matter (e.g., the device CMC 114) can employ to communicate uplink data packet delay information to the base station 106 (e.g., to the CMC 112 of the base station 106), and, in other embodiments, the device CMC 114 can utilize another desired format or no particular format to communicate the uplink data packet delay information to the base station 106.

In some embodiments, the device CMC 114 can comprise a communicator component 606 that can handle (e.g., manage or execute) or facilitate handling data transfers, including the communication or transfer of uplink data packets, to desired destinations (e.g., desired services, devices, or components). In accordance with various embodiments, the device, employing the communicator component 606, can communicate the uplink data packet delay information, in the desired format (e.g., example uplink data packet delay format 700), to the base station 106 with the uplink data packet or at another desired (e.g., wanted, suitable, permitted, authorized, or otherwise desired) time (e.g., prior to or after communicating the uplink data packet to the base station 106). The base station 106 (e.g., the CMC 112 of the base station 106) can receive the uplink data packet and the associated uplink data packet delay information.

The CMC 112, employing a grant determination component 510, can determine (e.g., calculate) a subsequent (e.g., next) uplink grant time (e.g., periodic uplink grant time or configured grant time) for a subsequent (e.g., next) uplink data packet associated with the device 108 and/or the service, based at least in part on the uplink data packet delay information. As part of, and/or as a result of, the uplink grant determination, the grant determination component 510 can determine whether the subsequent uplink grant time associated with the subsequent uplink data packet is to adjusted (e.g., modified or shifted) to a different (e.g., earlier) time slot in the subsequent (e.g., next) frame associated with a subsequent (e.g., next) SFN relative to (e.g., as compared to) the time slot the uplink data packet was in in the most recent frame associated with the most recent SFN, and/or, with regard to a configured grant, whether the configured grant is to be reconfigured, such as described herein.

With regard to periodic uplink grants, if periodic uplink grants are being utilized to facilitate communication of uplink data packets associated with the service from the device 108 to the base station 106, the grant determination component 510 can determine the subsequent uplink grant based at least in part on (e.g., as a function of) the previous (e.g., most recent) uplink grant time, the uplink grant period, the uplink data packet delay, a defined uplink grant jitter threshold (e.g., a defined threshold amount of uplink grant jitter) associated with the service, the device 108, and/or uplink grants, and/or another desired factor (e.g., attribute or characteristic). For instance, the grant determination component 510 can analyze information relating to the previous uplink grant time, the uplink grant period, the uplink data packet delay (e.g., uplink data packet delay information), and/or the defined uplink grant jitter threshold. Based at least in part on the results of the analysis of such information, the grant determination component 510 can determine whether the uplink data packet delay is greater than the defined threshold uplink grant jitter, or is less than or equal to the defined threshold uplink grant jitter.

If, based at least in part on the analysis results, the grant determination component 510 determines that the uplink data packet delay is greater than the defined threshold uplink grant jitter, the grant determination component 510 can determine the subsequent uplink grant time based at least in part on (e.g., as a function of) the previous uplink grant time, the uplink grant period, the uplink data packet delay, and/or the defined uplink grant jitter threshold. For example, if the grant determination component 510 determines that the uplink data packet delay is greater than the defined threshold uplink grant jitter, the grant determination component 510 can determine the subsequent uplink grant time as equal to the previous uplink grant time plus the uplink grant period minus the combined total of the uplink data packet delay minus the defined uplink grant jitter threshold (e.g., the previous uplink grant time+the uplink grant period−(the uplink data packet delay−the defined uplink grant jitter threshold)).

If, instead, based at least in part on the analysis results, the grant determination component 510 determines that the uplink data packet delay is less than or equal to the defined threshold uplink grant jitter, the grant determination component 510 can determine the subsequent uplink grant time based at least in part on (e.g., as a function of) the previous uplink grant time and the uplink grant period. For example, if the grant determination component 510 determines that the uplink data packet delay is less than or equal to the defined threshold uplink grant jitter, the grant determination component 510 can determine the subsequent uplink grant time as equal to the previous uplink grant time plus the uplink grant period (e.g., the previous uplink grant time+the uplink grant period). That is, in such instance, the subsequent uplink grant time can have a time location (e.g., time slot) in the subsequent frame that can correspond to the previous time location in the previous frame for the previous uplink grant time.

In some embodiments, the device 108 may not send uplink data packet delay information associated with an uplink data packet to the base station 106. For instance, if an amount of uplink data packet delay associated with an uplink data packet is the same amount of uplink data packet delay associated with a previous (e.g., most recent or last) uplink data packet, the device 108 does not have to communicate the uplink data packet delay information indicating the amount of uplink data packet delay associated with the uplink data packet. If the CMC 112 does not receive uplink data packet delay information in connection with receiving an uplink data packet, the grant determination component 510 can determine the subsequent uplink grant time based at least in part on the previous uplink grant time and the uplink grant period. For instance, in response to the CMC 112 determining that no uplink data packet delay information has been received in connection with receiving an uplink data packet from the device 108, the grant determination component 510 can determine the subsequent uplink grant time as equal to the previous uplink grant time plus the uplink grant period (e.g., the previous uplink grant time+the uplink grant period). That is, in such instance where uplink data packet delay information is not received, the subsequent uplink grant time can have a time location (e.g., time slot) in the subsequent frame that can correspond to the previous time location in the previous frame for the previous uplink grant time.

The scheduler component 508 of the CMC 112 can schedule the subsequent uplink grant (e.g., periodic uplink grant) at the subsequent uplink grant time for transmission of the subsequent uplink data packet from the device 108 to the base station 106, and can communicate DCI, comprising subsequent uplink grant information regarding the subsequent uplink grant, to the device 108, wherein the subsequent uplink grant information can indicate or specify the time (e.g., the time slot of a frame) that the device 108 can transmit the subsequent uplink data packet to the base station 106.

The device 108 can receive the DCI, including the subsequent uplink grant information, from the base station 106. The device CMC 114 can analyze the subsequent uplink grant information to determine the time of the subsequent uplink grant. The device CMC 114, employing the communicator component 606, can manage the communication of the subsequent data packet to communicate the subsequent uplink data packet to the base station 106 at the time indicated in the subsequent uplink grant information. In some embodiments, in connection with the communication of the subsequent uplink data packet, the device CMC 114 (e.g., employing the delay determination component 604) can determine uplink data packet delay associated with the communication of the subsequent uplink data packet to the base station 106 (e.g., uplink data packet delay can be equal to, or a function of, the time when the subsequent uplink data packet was generated or received (e.g., generation time) by the device 108 minus the time when the subsequent uplink data packet is sent (e.g., transmission time or subsequent uplink grant time)), such as described herein. If there has been a change in the amount of uplink data packet delay relative to the previous uplink data packet delay, the device CMC 114 can communicate uplink data packet delay information relating to the uplink data packet delay to the base station 106 in connection with communication of the subsequent uplink data packet, such as described herein.

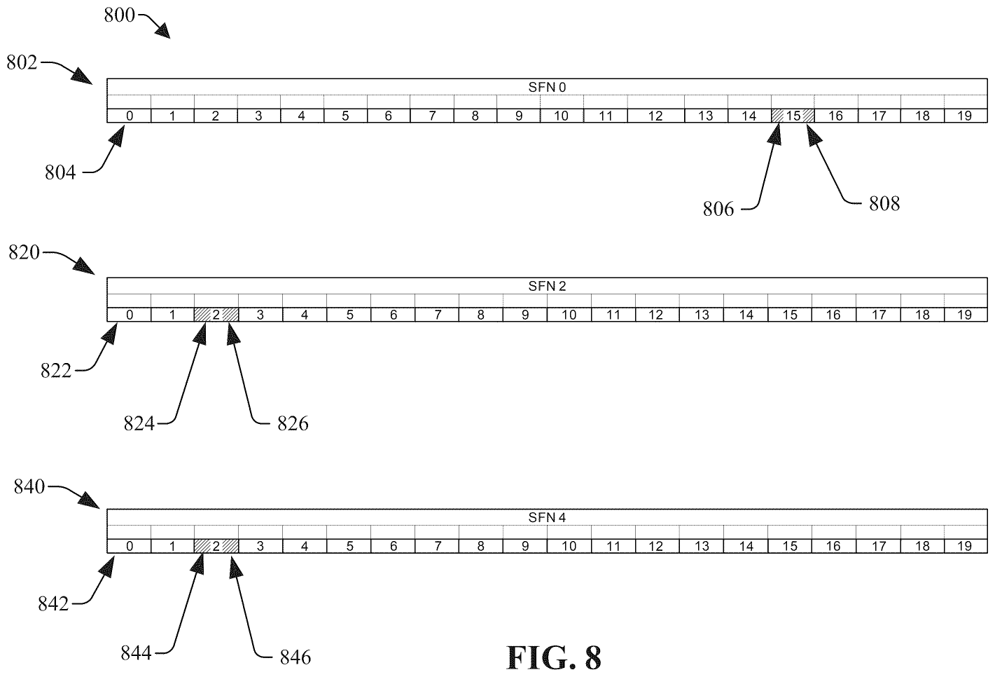

Referring to FIG. 8 (along with FIGS. 1, 5, and 6), FIG. 8 depicts a diagram of non-limiting example frames 800 that can be utilized to communicate uplink data packets from the device 108 to the base station 106 utilizing periodic uplink grants, in accordance with various aspects and embodiments of the disclosed subject matter. The non-limiting example frames 800 can relate to one particular non-limiting example scenario of utilizing and adjusting (e.g., customizing, tailoring, modifying, enhancing, or optimizing) periodic uplink grants to enhance communication of uplink data packets from the device 108 to the base station 106 and mitigating (e.g., reducing or minimizing uplink data packet delay) associated with the communication of uplink data packets.

In this non-limiting example scenario, the uplink grant period can be equal to 40 slots (e.g., 40 time slots), the threshold uplink grant jitter can be equal to 2 slots, the first uplink data packet associated with the service can be generated at SFN 0 slot 0, and the device 108 can send the first uplink data packet at SFN 0 slot 15 in accordance with the first uplink grant (e.g., first periodic uplink grant). The non-limiting example frames 800 can comprise a first frame 802 associated with SFN 0. As indicated at reference numeral 804, the first uplink data packet can be generated at SFN 0 slot 0. The device CMC 114 can store the first uplink data packet in the buffer component 602, while waiting for transmission to the base station 106.

In connection with the device 108 preparing to send the first uplink data packet to the base station 106, the scheduler component 508 of the CMC 112 (e.g., of the DU 504) can schedule the first uplink grant for communication of the first uplink data packet at SFN 0 slot 15, as indicated at reference numeral 806. The scheduler component 508 can generate first DCI, comprising first uplink grant information regarding the first uplink grant, and the CMC 112 can communicate the first DCI to the device 108. Before or in connection with the sending of the first DCI, the CMC 112 also can set up (e.g., establish) delay sensitive (e.g., delay critical) DRB associated with the service and/or the device 108.

The device 108 can receive the first DCI. The device CMC 114 can analyze the first DCI, including the first uplink grant information, and, based at least in part on the analysis results, can determine that the first uplink grant is scheduled for SFN 0 slot 15. The delay determination component 604 can determine first uplink data packet delay as a function of the time that the first uplink data packet was generated and the time that the first uplink data packet is being sent to the base station 106, in accordance with the first uplink grant. For example, the delay determination component 604 can determine the first uplink data packet delay as being equal to the time that the first uplink data packet was generated (SFN 0 slot 0) minus the time that the first uplink data packet is being sent to the base station 106 (SFN 0 slot 15), which can be 15 slots. The device CMC 114 can communicate first uplink data packet delay information relating to the first uplink data packet delay of 15 slots with, or in connection with, the communication of the first uplink data packet to the base station 106 at the time of the first uplink grant (e.g., SFN 0 slot 15), as indicated at reference numeral 808. For instance, the device CMC 114 can communicate the uplink delay MAC CE with the first uplink data packet delay information to the base station 106.

The base station 106 (e.g., the DU 504) can receive the first uplink data packet and the first uplink data packet delay information (e.g., via the uplink delay MAC CE) from the device 108. The CMC 112 can analyze the first uplink data packet delay information, and, based at least in part on the analysis results, can determine that the first uplink data packet delay is 15 slots. Also, as part of its analysis, the CMC 112, employing the grant determination component 510, can analyze the determine the first uplink data packet delay, the defined threshold uplink grant jitter, and/or other desired information, and, based at least in part on the results of such analysis, can determine, or at least essentially can determine, whether a time of a second (e.g., subsequent or next) periodic uplink grant for a second uplink data packet associated with the service and/or device 108 is to be adjusted relative the time of the first periodic uplink grant for the first uplink data packet. For instance, based at least in part on the results of analyzing the first uplink data packet delay, the defined threshold uplink grant jitter, and/or other desired information, the grant determination component 510 can determine that the amount of the first uplink data packet delay (e.g., 15 slots) is greater than the defined threshold uplink grant jitter (e.g., 2 slots), and accordingly, can determine that the time of the second periodic uplink grant for the second uplink data packet can be adjusted relative the time of the first periodic uplink grant for the first uplink data packet to mitigate (e.g., reduce or minimize) uplink data packet delay.

Since the grant determination component 510 determined that the amount of the first uplink data packet delay (e.g., 15 slots) is greater than the defined threshold uplink grant jitter (e.g., 2 slots), the grant determination component 510 can determine the second (e.g., subsequent) uplink grant time based at least in part on (e.g., as a function of) the first (e.g., previous) uplink grant time, the uplink grant period, the first uplink data packet delay, and/or the defined uplink grant jitter threshold. For example, in response to determining that the first uplink data packet delay is greater than the defined threshold uplink grant jitter, the grant determination component 510 can determine the second uplink grant time as equal to the first uplink grant time plus the uplink grant period minus the combined total of the first uplink data packet delay minus the defined uplink grant jitter threshold (e.g., SFN 0 slot 0+40 slots−(15 slots−2 slots)), which can be SFN 2 slot 2.

With regard to the second uplink data packet and the second uplink grant time, the non-limiting example frames 800 can comprise a second frame 820 associated with SFN 2. As indicated at reference numeral 822, the device 108 can generate the second uplink data packet at or in accordance with time SFN 2 slot 0. The device CMC 114 can store the second uplink data packet in the buffer component 602 while waiting for transmission to the base station 106.

In connection with the device 108 preparing to send the second uplink data packet to the base station 106, the scheduler component 508 of the CMC 112 can schedule the second uplink grant (e.g., second periodic uplink grant) for communication of the second uplink data packet at SFN 2 slot 2, in accordance with second uplink grant time determined by the grant determination component 510, as indicated at reference numeral 824. The scheduler component 508 can generate second DCI, comprising second uplink grant information regarding the second uplink grant, and the CMC 112 can communicate the second DCI to the device 108.

The device 108 can receive the second DCI. The device CMC 114 can analyze the second DCI, including the second uplink grant information, and, based at least in part on the analysis results, can determine that the second uplink grant is scheduled for SFN 2 slot 2. The delay determination component 604 can determine second uplink data packet delay as a function of the time that the second uplink data packet was generated and the time that the second uplink data packet is being sent to the base station 106, in accordance with the second uplink grant. For example, the delay determination component 604 can determine the second uplink data packet delay as being equal to the time that the second uplink data packet was generated (SFN 2 slot 0) and the time that the second uplink data packet is being sent to the base station 106 (SFN 2 slot 2), which can be 2 slots. The device CMC 114 can communicate second uplink data packet delay information relating to the second uplink data packet delay of 2 slots with, or in connection with, the communication of the second uplink data packet to the base station 106 at the time of the second uplink grant (e.g., SFN 2 slot 2), as indicated at reference numeral 826. For instance, the device CMC 114 can communicate the uplink delay MAC CE with the second uplink data packet delay information to the base station 106.

The base station 106 (e.g., the DU 504) can receive the second uplink data packet and the second uplink data packet delay information (e.g., via the uplink delay MAC CE) from the device 108. The CMC 112 can analyze the second uplink data packet delay information, and, based at least in part on the analysis results, can determine that the second uplink data packet delay is 2 slots. Also, as part of its analysis, the CMC 112, employing the grant determination component 510, can analyze the second uplink data packet delay, the defined threshold uplink grant jitter, and/or other desired information, and, based at least in part on the results of such analysis, can determine, or at least essentially can determine, whether a time of a third (e.g., another subsequent or next) periodic uplink grant for a third uplink data packet associated with the service and/or device 108 is to be adjusted relative the time of the second periodic uplink grant for the second uplink data packet. In this example scenario, based at least in part on the results of analyzing the second uplink data packet delay, the defined threshold uplink grant jitter, and/or other desired information, the grant determination component 510 can determine that the amount of the second uplink data packet delay (e.g., 2 slots) is less than or equal to the defined threshold uplink grant jitter (e.g., 2 slots), and accordingly, can determine that the time of the third periodic uplink grant for the third uplink data packet is not to be adjusted relative the time of the second periodic uplink grant for the second uplink data packet, as the amount of the second uplink data packet delay is as low as it can be without having communication of the third uplink data packet fall within the defined threshold uplink grant jitter.

Since the grant determination component 510 determined that the amount of the second uplink data packet delay (e.g., 2 slots) is less than or equal to the defined threshold uplink grant jitter (e.g., 2 slots), the grant determination component 510 can determine the third (e.g., another subsequent) uplink grant time based at least in part on (e.g., as a function of) the second (e.g., previous) uplink grant time and the uplink grant period. For instance, in response to determining that the second uplink data packet delay is less than or equal to the defined threshold uplink grant jitter, the grant determination component 510 can determine the third uplink grant time as equal to the second uplink grant time plus the uplink grant period (e.g., SFN 2 slot 0+40 slots), which can be SFN 4 slot 2.

With regard to the third uplink data packet and the third uplink grant time, the non-limiting example frames 800 can comprise a third frame 840 associated with SFN 4. As indicated at reference numeral 842, the device 108 can generate the third uplink data packet at or in accordance with time SFN 4 slot 0. The device CMC 114 can store the third uplink data packet in the buffer component 602 while waiting for transmission to the base station 106.

In connection with the device 108 preparing to send the third uplink data packet to the base station 106, the scheduler component 508 of the CMC 112 can schedule the third uplink grant (e.g., third periodic uplink grant) for communication of the third uplink data packet at SFN 4 slot 2, in accordance with third uplink grant time determined by the grant determination component 510, as indicated at reference numeral 844. The scheduler component 508 can generate third DCI, comprising third uplink grant information regarding the third uplink grant, and the CMC 112 can communicate the third DCI to the device 108.

The device 108 can receive the third DCI. The device CMC 114 can analyze the third DCI, including the third uplink grant information, and, based at least in part on the analysis results, can determine that the third uplink grant is scheduled for SFN 4 slot 2. The delay determination component 604 can determine third uplink data packet delay as a function of the time that the third uplink data packet was generated and the time that the third uplink data packet is being sent to the base station 106, in accordance with the third uplink grant. For instance, the delay determination component 604 can determine the third uplink data packet delay as being equal to the time that the third uplink data packet was generated (SFN 4 slot 0) and the time that the third uplink data packet is being sent to the base station 106 (SFN 4 slot 2), which can be 2 slots. The device CMC 114 can determine that the third uplink data packet delay (e.g., 2 slots) is the same as the second uplink data packet delay (e.g., 2 slots), based at least in part on the results of analyzing (e.g., comparing) the third uplink data packet delay and the second uplink data packet delay. Since the third uplink data packet delay and the second uplink data packet delay are determined to be the same, the device CMC 114 can determine that the third uplink data packet delay does not have to be sent to the base station 106 (e.g., the DU 504 of the base station 106), and, accordingly, does not send third uplink data packet delay information regarding the third uplink data packet delay (e.g., does not send uplink delay MAC CE) to the base station 106 in connection with the communication of the third uplink data packet to the base station 106. The device CMC 114 can communicate the third uplink data packet to the base station 106 (e.g., with no uplink delay MAC CE) at the time of the third uplink grant (e.g., SFN 4 slot 2), as indicated at reference numeral 846.

The base station 106 (e.g., the DU 504) can receive, from the device 108, the third uplink data packet with no uplink data delay information (e.g., no uplink delay MAC CE) being included or received in connection therewith. In this example scenario, since no uplink data delay information (e.g., no uplink delay MAC CE) was included or received in connection with the communication of the third uplink data packet to the base station 106, the CMC 112 can determine or at least infer that the third uplink data packet delay is the same as the second uplink data packet delay. Since it has been determined that the third uplink data packet delay is the same as the second uplink data packet delay, the grant determination component 510 can determine, or at least essentially can determine, that a time of a fourth (e.g., yet another subsequent or next) periodic uplink grant for a fourth uplink data packet associated with the service and/or device 108 is not to be adjusted relative the time of the third periodic uplink grant for the third uplink data packet, as the amount of the second uplink data packet delay is as low as it can be without having communication of the fourth uplink data packet fall within the defined threshold uplink grant jitter.

Since it was determined that no uplink data delay information was included or received in connection with the third uplink data packet (and thus, the third uplink data packet delay is the same as the second uplink data packet delay), the grant determination component 510 can determine the fourth (e.g., yet another subsequent) uplink grant time based at least in part on (e.g., as a function of) the third (e.g., previous) uplink grant time and the uplink grant period. For instance, the grant determination component 510 can determine the fourth uplink grant time as equal to the third uplink grant time plus the uplink grant period (e.g., SFN 4 slot 0+40 slots), which can be SFN 6 slot 2. The base station 106 (e.g., including the DU 504 and CMC 112) and the device 108 (e.g., including the device CMC 114) can continue to perform their respective operations relating to communication of uplink data packets utilizing periodic uplink grants with regard to the fourth uplink data packet and/or any other subsequent uplink data packets associated with the service and/or the device 108, such as described herein.

It is to be appreciated and understood that the non-limiting example scenario described with regard to the non-limiting example frames 800 depicted in FIG. 8 is but one scenario that can occur with regard to periodic uplink grants. In other scenarios and embodiments, there can be different uplink grant periods, different times for generation of uplink data packets, different threshold uplink grant jitter, different periodic uplink grants, different uplink grant time slots, different amounts of uplink data packet delay, and/or other different features or characteristics than those presented with regard to the non-limiting example scenario described with regard to the non-limiting example frames 800 depicted in FIG. 8, and the device 108 (e.g., employing the device CMC 114) and the base station 106 (e.g., employing the CMC 112) can perform respective operations, processes, and/or methods, using the techniques described herein, to desirably manage periodic uplink grants and communicating of uplink data using periodic uplink grants, while mitigating uplink data packet delay.

With regard to configured grants, the techniques, operations, and/or processes that can be utilized, performed, and/or executed by the base station 106 (e.g., including the DU 504 and CMC 112) and the device 108 (e.g., including the device CMC 114) can be similar to the techniques, operations, and/or processes that can be utilized, performed, and/or executed by the base station 106 and the device 108 with regard to periodic uplink grants, although there can be some differences. As disclosed, in the case of a configured grant, the device 108 can send uplink data when the configured grant slot occurs. To mitigate (e.g., reduce or minimize) uplink data delay associated with configured grants, the base station 106 (e.g., CMC 112 of the base station 106) desirably can configure the configured grant time domain allocation as close to the time slot (e.g., of the frame) when the uplink data packet is generated by the device 108. To facilitate achieving this, the device 108, employing the device CMC 114, can provide uplink data packet delay information relating to uplink data packet delay associated with an uplink data packet associated with the service and/or device 108 in connection with the device 108 communicating the uplink data packet to the base station 106. Based at least in part on the uplink data packet delay reported by the device 108, the base station 106 (e.g., the CMC 112 and/or DU 504) can determine whether to reconfigure the time domain allocation for the configured grant associated with the device 108, and/or, if it determines that reconfiguration of the time domain allocation for the configured grant is to be performed, can reconfigure the time domain allocation for the configured grant via DCI, such as described herein.

When configured grants are being utilized to facilitate communication of uplink data packets associated with the service from the device 108 to the base station 106, the CMC 112, employing a reconfiguration determination component 512, can determine whether the time domain allocation for the configured grant is to be reconfigured based at least in part on the uplink data packet delay associated with an uplink data packet and the defined uplink grant jitter threshold. If, based at least in part on the results of analyzing (e.g., comparing) the uplink data packet delay and the defined uplink grant jitter threshold, the reconfiguration determination component 512 determines that the uplink data packet delay is less than or equal to the defined uplink grant jitter threshold, the reconfiguration determination component 512 can determine that the configured grant is not to be reconfigured (e.g., the time domain allocation for the configured grant is not to be reconfigured), and the configured grant can continue as is with regard to the scheduling of configured grant time slots (e.g., the subsequent uplink grant time slot can be equal to the current uplink grant time slot associated with the uplink data packet+the uplink grant period).

If, instead, based at least in part on the results of analyzing (e.g., comparing) the uplink data packet delay and the defined uplink grant jitter threshold, the reconfiguration determination component 512 determines that the uplink data packet delay is greater than the defined uplink grant jitter threshold, the reconfiguration determination component 512 can determine that the configured grant is to be reconfigured (e.g., the time domain allocation for the configured grant is to be reconfigured). In response to a determination that the configured grant is to be reconfigured, the grant determination component 510 can determine (e.g., calculate) a subsequent (e.g., next) configured grant time slot for a subsequent uplink data packet associated with the service and/or device 108 based at least in part on (e.g., as a function of) the current (e.g., most recent) uplink grant time, the uplink grant period, the uplink data packet delay, the defined uplink grant jitter threshold, and/or another desired factor. For instance, the grant determination component 510 can analyze information relating to the current uplink grant time, the uplink grant period, the uplink data packet delay (e.g., uplink data packet delay information), and/or the defined uplink grant jitter threshold. Based at least in part on the results of the analysis of such information, the grant determination component 510 can determine the subsequent configured grant time slot as equal to the current uplink grant time plus the uplink grant period minus the combined total of the uplink data packet delay minus the defined uplink grant jitter threshold (e.g., the current uplink grant time+the uplink grant period−(the uplink data packet delay−the defined uplink grant jitter threshold)).

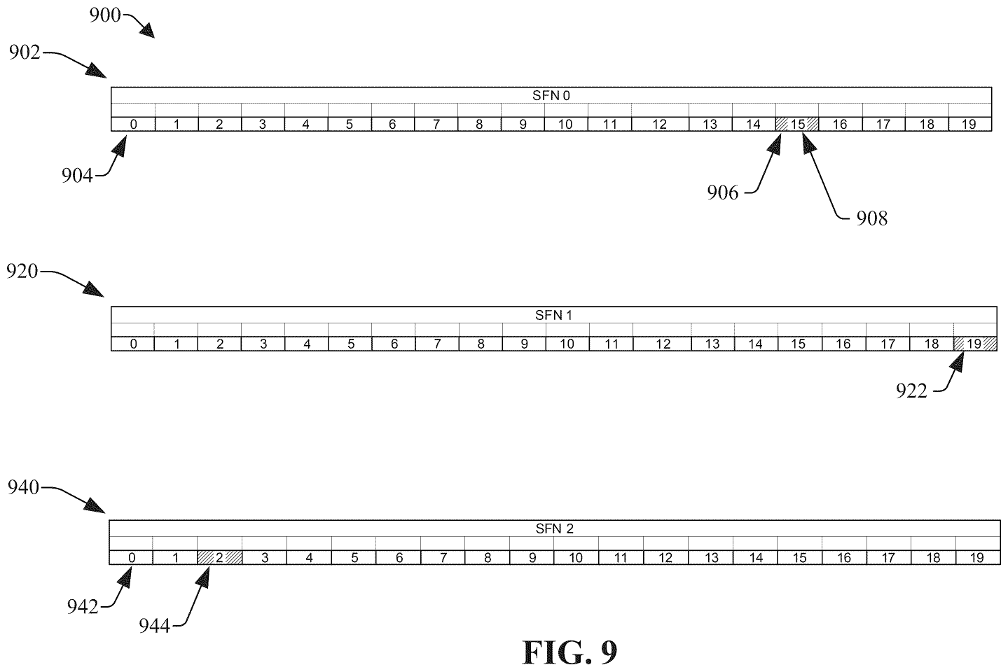

Referring to FIG. 9 (along with FIGS. 1, 5, and 6), FIG. 9 illustrates a diagram of non-limiting example frames 900 that can be utilized to communicate uplink data packets from the device 108 to the base station 106 utilizing a configured grant, in accordance with various aspects and embodiments of the disclosed subject matter. The non-limiting example frames 900 can relate to one particular non-limiting example scenario of utilizing and adjusting (e.g., customizing, tailoring, modifying, enhancing, or optimizing) and/or reconfiguring a configured uplink grant to enhance communication of uplink data packets from the device 108 to the base station 106 and mitigating (e.g., reducing or minimizing uplink data packet delay) associated with the communication of uplink data packets.

In this non-limiting example scenario, the configured grant period can be equal to 40 slots (e.g., 40 time slots), the threshold uplink grant jitter can be equal to 2 slots, the first uplink data packet associated with the service can be generated at SFN 0 slot 0, and the device 108 can send the first uplink data packet at SFN 0 slot 15 in accordance with a first configured time slot associated with a first configured grant. The non-limiting example frames 900 can comprise a first frame 902 associated with SFN 0. As indicated at reference numeral 904, the device 108 can generate the first uplink data packet at SFN 0 slot 0. The device CMC 114 can store the first uplink data packet in the buffer component 602, while waiting for transmission to the base station 106.

In this example scenario relating to the configured grant, in connection with the device 108 preparing to send the first uplink data packet to the base station 106, the scheduler component 508 of the CMC 112 (e.g., of the DU 504) can schedule the first configured grant time slot associated with the first configured grant for communication of the first uplink data packet at SFN 0 slot 15, as indicated at reference numeral 906. The scheduler component 508 can generate first DCI, comprising first configured grant activation information and first configured grant information regarding the first configured grant. The first configured grant activation information can facilitate activation of the first configured grant by the device 108. The CMC 112 can communicate the first DCI to the device 108. Before or in connection with the sending of the first DCI, the CMC 112 also can set up (e.g., establish) delay sensitive (e.g., delay critical) DRB associated with the service and/or the device 108.

The device 108 can receive the first DCI. The device CMC 114 can analyze the first DCI, including the first configured grant activation information and the first uplink grant information. Based at least in part on the analysis results, the device CMC 114 can determine that the first configured grant slot is scheduled for SFN 0 slot 15, and can enable or activate the first configured grant for the device 108. The delay determination component 604 can determine first uplink data packet delay as a function of the time that the first uplink data packet was generated and the time that the first uplink data packet is being sent to the base station 106, in accordance with the first configured grant time slot. For example, the delay determination component 604 can determine the first uplink data packet delay as being equal to the time that the first uplink data packet was generated (SFN 0 slot 0) minus the time that the first uplink data packet is being sent to the base station 106 (SFN 0 slot 15), which can be 15 slots. The device CMC 114 can communicate first uplink data packet delay information relating to the first uplink data packet delay of 15 slots with, or in connection with, the communication of the first uplink data packet to the base station 106 at the time of the first configured grant slot (e.g., SFN 0 slot 15), as indicated at reference numeral 908. For instance, the device CMC 114 can communicate the uplink delay MAC CE with the first uplink data packet delay information to the base station 106.

The base station 106 (e.g., the DU 504) can receive the first uplink data packet and the first uplink data packet delay information (e.g., via the uplink delay MAC CE) from the device 108. In accordance with this example scenario, the CMC 112 can analyze the first uplink data packet delay information, and, based at least in part on the analysis results, can determine that the first uplink data packet delay is 15 slots. Also, as part of its analysis, the CMC 112, employing the reconfiguration determination component 512, can analyze the determine the first uplink data packet delay, the defined threshold uplink grant jitter, and/or other desired information, and, based at least in part on the results of such analysis, can determine whether the first configured grant is to be reconfigured (e.g., the time domain allocation for the first configured grant is to be reconfigured). For instance, based at least in part on the results of analyzing the first uplink data packet delay, the defined threshold uplink grant jitter, and/or other desired information, the reconfiguration determination component 512 can determine that the amount of the first uplink data packet delay (e.g., 15 slots) is greater than the defined threshold uplink grant jitter (e.g., 2 slots), and accordingly, can determine that the first configured grant is to be reconfigured to mitigate (e.g., reduce or minimize) uplink data packet delay.

Since the reconfiguration determination component 512 determined that the amount of the first uplink data packet delay (e.g., 15 slots) is greater than the defined threshold uplink grant jitter (e.g., 2 slots), the grant determination component 510 can determine a second (e.g., new or reconfigured) configured grant time slot based at least in part on (e.g., as a function of) the first configured grant time slot (e.g., the current time slot), the uplink grant period, the first uplink data packet delay, and/or the defined uplink grant jitter threshold. For example, in response to the reconfiguration determination component 512 determining that the first uplink data packet delay is greater than the defined threshold uplink grant jitter, the grant determination component 510 can determine the second configured grant time slot as equal to the first configured grant time slot plus the uplink grant period minus the combined total of the first uplink data packet delay minus the defined uplink grant jitter threshold (e.g., SFN 0 slot 0+40 slots−(15 slots−2 slots)), which can be SFN 2 slot 2.

In connection with the second uplink data packet and the second configured grant time slot, the non-limiting example frames 900 can comprise a second frame 920 associated with SFN 1. The scheduler component 508 can schedule second DCI, comprising configured grant reconfiguration information for configured grant reconfiguration, at a desired time slot that can be prior to the second configured grant time slot to be utilized to communicate a second uplink data packet associated with the service and/or device 108. In some embodiments, the scheduler component 508 (or another component of the CMC 112) can determine a time slot for communication of the second DCI based at least in part on (e.g., as a function of) the second configured grant time slot and a defined factor (e.g., k2). For example, the scheduler component 508 (or another component of the CMC 112) can determine the time slot for communication of the second DCI as being equal to the configured grant time slot (e.g., the second configured grant time slot) minus the defined factor (e.g., k2). In certain embodiments, the defined factor can indicate a number of time slots that can or are to be between transmission of DCI (e.g., physical downlink control channel (PDCCH)/DCI) and transmission of uplink data (e.g., physical uplink shared channel (PUSCH) transmission). In this example scenario, if the defined factor (e.g., k2) equals 3 time slots, the scheduler component 508 (or another component of the CMC 112) can determine that the second DCI for configured grant configuration is to be scheduled at SFN 1 slot 19 (e.g., SFN 2 slot 2-3 time slots), which is 3 time slots before the second configured grant time slot. Accordingly, the scheduler component 508 can schedule the second DCI for configured grant configuration at SFN 1 slot 19, as indicated at reference numeral 922, to facilitate reconfiguring the first configured grant to a second configured grant, wherein the second configured grant time slot can correspond to or be part of the second configured grant, and can facilitate the scheduling and/or communication of the second uplink data packet by the device 108 at the second configured grant time slot. The CMC 112 can communicate the second DCI for configured grant configuration to the device 108 at SFN 1 slot 19, as scheduled.

The device 108 can receive the second DCI for configured grant configuration. The device CMC 114 can analyze the second DCI for configured grant configuration, which can comprise the configured grant reconfiguration information. Based at least in part on the results of such analysis, and in accordance with the configured grant reconfiguration information, the device CMC 114, employing a reconfiguration component 608, can reconfigure the first configured grant to the second configured grant. This reconfiguration to the second configured grant by the reconfiguration component 608 can adjust (e.g., modify, improve, or optimize) the configured grant timer to have one or more future configured grant time slots (e.g., the second configured grant time slot and/or one or more other subsequent configured grant time slots) be at a different time slot number in one or more future frames (e.g., frame associated with SFN 2 and/or one or more other subsequent frames associated with subsequent SFNs) such that the future configured grant time slot(s) can be closer in time to the time that the uplink data packet(s) associated with the service and/or device 108 is generated) to facilitate mitigating uplink grant time delay. In some embodiments, the reconfiguration component 608 can reconfigure the configured grant timer in accordance with (e.g., as defined by) 3^{rd} Generation Partnership Project (3GPP) 38.321, section 5.8.2. In other embodiments, the reconfiguration component 608 can reconfigure the configured grant timer using and/or in accordance with another desired protocol, provision, process, or technique. In this example scenario, after reconfiguration from the first configured grant to the second configured grant has been completed, the initial configured grant time slot under the second configured grant can occur at SFN 2 slot 2.

With further regard to the second uplink data packet and the second configured grant time slot, the non-limiting example frames 900 can comprise a third frame 940 associated with SFN 2. In accordance with this example scenario, as indicated at reference numeral 942, the device 108 can generate the second uplink data packet at SFN 2 slot 0. The device 108 can store the second uplink data packet in the buffer component 602 while waiting to transmit the second uplink data packet to the base station 106 at the second configured grant time slot (e.g., SFN 2 slot 2).

The device CMC 114, employing the delay determination component 604, can determine second uplink data packet delay as a function of the time that the second uplink data packet was generated and the time that the second uplink data packet is being sent to the base station 106, in accordance with the second configured grant time slot of the second configured grant. For example, the delay determination component 604 can determine the second uplink data packet delay as being equal to the time that the second uplink data packet was generated (SFN 2 slot 0) minus the time that the second uplink data packet is being sent to the base station 106 (SFN 2 slot 2), which can be 2 slots. The device CMC 114 can communicate second uplink data packet delay information relating to the second uplink data packet delay of 2 slots with, or in connection with, the communication of the second uplink data packet to the base station 106 at the time of the second configured grant slot (e.g., SFN 2 slot 2), as indicated at reference numeral 944. For instance, the device CMC 114 can communicate the uplink delay MAC CE with the second uplink data packet delay information to the base station 106.

The base station 106 (e.g., the DU 504 of the base station 106) can receive the second uplink data packet and the second uplink data packet information (e.g., uplink delay MAC CE). The CMC 112 can analyze the second uplink data packet delay information, and, based at least in part on the analysis results, can determine that the second uplink data packet delay is 2 slots. Also, as part of its analysis, the CMC 112, employing the reconfiguration determination component 512, can analyze the second uplink data packet delay, the defined threshold uplink grant jitter, and/or other desired information, and, based at least in part on the results of such analysis, can determine whether the second configured grant is to be reconfigured (e.g., the time domain allocation for the second configured grant is to be reconfigured). For instance, based at least in part on the results of analyzing the second uplink data packet delay, the defined threshold uplink grant jitter, and/or other desired information, the reconfiguration determination component 512 can determine that the amount of the second uplink data packet delay (e.g., 2 slots) is less than or equal to the defined threshold uplink grant jitter (e.g., 2 slots), and accordingly, can determine that the second configured grant is not to be reconfigured, as the amount of the second uplink data packet delay is as low as it can be without having communication of a third uplink data packet associated with the service and/or device 108 fall within the defined threshold uplink grant jitter.

Accordingly, in this example scenario, since the reconfiguration determination component 512 determined that the second configured grant is not to be reconfigured, no reconfiguration of the second configured grant will be performed, and the device 108 and the base station 106 can continue to operate, in accordance with the second configured grant, so long as there is not a change in the uplink data packet delay that causes it to be greater than the defined threshold uplink grant jitter. As a result, the device 108 can communicate the third uplink data packet (and associated third uplink data packet delay) to the base station 106 at a third configured grant time slot (e.g., SFN 4 slot 2), a fourth uplink data packet (and associated fourth uplink data packet delay) to the base station 106 at a fourth configured grant time slot (e.g., SFN 6 slot 2), and/or another uplink data packet(s) (and another associated uplink data packet delay(s)) to the base station 106 at another configured grant time slot(s) (e.g., SFN 8 slot 2), in accordance with the second configured grant, without the device 108 having to receive DCI from the base station 106, provided that there is not a change in the uplink data packet delay that causes it to be greater than the defined threshold uplink grant jitter.

It is to be appreciated and understood that the non-limiting example scenario described with regard to the non-limiting example frames 900 depicted in FIG. 9 is but one scenario that can occur with regard to configured grants. In other scenarios and embodiments, there can be different uplink grant periods, different times for generation of uplink data packets, different threshold uplink grant jitter, different configured grants, different configured grant time slots, different amounts of uplink data packet delay, and/or other different features or characteristics than those presented with regard to the non-limiting example scenario described with regard to the non-limiting example frames 900 depicted in FIG. 9, and the device 108 (e.g., employing the device CMC 114) and the base station 106 (e.g., employing the CMC 112) can perform respective operations, processes, and/or methods, using the techniques described herein, to desirably manage configured grants and communicating of uplink data using configured grants, while mitigating uplink data packet delay.

In some embodiments, as disclosed, the system 100, employing the CMC 112 and device CMC 114, can desirably (e.g., suitably, reliably, efficiently, enhancedly, and/or optimally) operate to mitigate (e.g., reduce or minimize) undesirable discarding of uplink data packets with regard to HARQ retransmission of uplink data packets due to uplink data packet delay by mitigating the effect of the uplink data packet delay. In certain embodiments, the CMC 112 can prioritize HARQ retransmission of uplink data packets, based at least in part on an available packet delay budget that can account for and mitigate uplink data packet delay, to mitigate undesirable discarding of uplink data packets with regard to HARQ retransmission.

The base station 106 (e.g., the CMC 112 of the base station 106) can receive, from the device 108, uplink data packet delay information associated with transmission of an uplink data packet(s) from the device 108 to the base station 106. The device 108 can determine (e.g., calculate) the uplink data packet delay associated with the uplink data packet, and generate the uplink data packet delay information, which can indicate or specify the uplink data packet delay, such as described herein.

In some embodiments, the CMC 112 can monitor transmission (e.g., uplink transmission) of uplink data packets from the device 108 to the base station 106 to facilitate determining whether a CRC failure is detected. The CMC 112 can employ a CRC failure detector component 514 that can analyze the uplink data packets (e.g., transmitted uplink data packets) and associated information (e.g., metadata, such as error detection bits or code) as part of performing a CRC process. Based at least in part on the results of such analysis and/or the performing of the CRC process, the CRC failure detector component 514 can determine whether a CRC failure has been detected with regard to the transmission of an uplink data packet associated with the device 108 (e.g., communicated from the device 108 to, or at least destined to, the base station 106).

If, based at least in part on the results of such analysis, no CRC failure has been detected with regard to transmission of an uplink data packet associated with the device 108, the CMC 112 can continue to monitor the transmission of uplink data packets associated with the device 108, and determine whether a CRC failure is detected. If, instead, based at least in part on the results of such analysis, the CRC failure detector component 514 determines that a CRC failure has been detected with regard to transmission of an uplink data packet associated with the device 108, HARQ retransmission of the uplink data packet can triggered or initiated.

In response to, or in connection with, detecting the CRC failure and/or the triggering or initiating of the HARQ retransmission, the CMC 112 can employ a retransmission manager component 516 that can determine an available packet delay budget associated with uplink HARQ retransmission based at least in part on (e.g., as a function of) the packet delay budget associated with the uplink HARQ retransmission and the amount of the uplink data packet delay. In some embodiments, the retransmission manager component 516 can determine (e.g., calculate) the available packet delay budget associated with the uplink HARQ retransmission as being equal to the packet delay budget minus the uplink data packet delay.

The CMC 112, employing the scheduler component 508 and/or the retransmission manager component 516, can prioritize HARQ retransmission of the uplink data packet(s) based at least in part on the available packet delay budget, to facilitate mitigating (e.g., reducing or minimizing) discarding of uplink data packets. For instance, the scheduler component 508 and/or the retransmission manager component 516 can prioritize (e.g., expedite execution of) the HARQ retransmission of the uplink data packet(s) utilizing the smallest value of the available packet delay budget. This prioritization of HARQ retransmission of uplink data packets can ensure that HARQ retransmission of uplink data packets associated with the device 108 are still attempted and/or completed within the packet delay budget (e.g., within the available packet delay budget, which can be smaller than the packet delay budget.

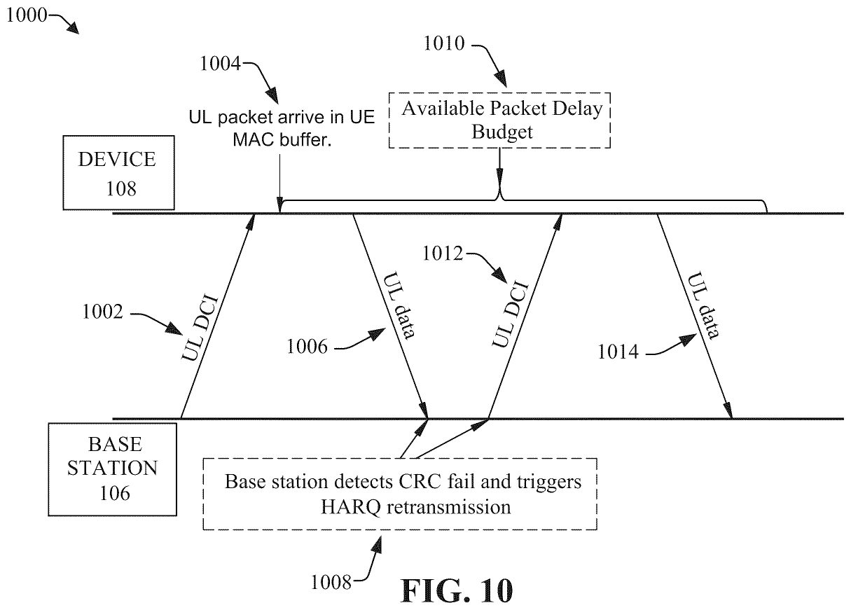

Referring to FIG. 10 (along with FIGS. 1, 5, and 6), FIG. 10 depicts a diagram of an example HARQ retransmission scenario 1000 that can illustrate an instance where the packet delay budget for HARQ retransmission of an uplink data packet has been adjusted to account for and mitigate uplink data packet delay to facilitate prioritizing HARQ retransmission of the uplink data packet and mitigate undesirable discarding of uplink data packets with regard to HARQ retransmission, in accordance with various aspects and embodiments of the disclosed subject matter. In connection with an uplink data packet associated with the service being generated by the device 108, the base station 106 can communicate DCI, comprising uplink grant information, to the device 108, indicated at reference numeral 1002, such as described herein. The uplink grant information can indicate the time (e.g., time slot during a frame associated with an SFN) that the uplink data packet can be transmitted by the device 108 to the base station 106. The device 108 can generate the uplink data packet and store the uplink data packet in the buffer component 602 of the device 108, as indicated at reference numeral 1004, where the uplink data packet may wait in the buffer component 602 until the time of the uplink grant.

The device 108 can transmit the uplink data packet to, or at least towards, the base station 106 at the time of the uplink grant, in accordance with the uplink grant, as indicated at reference numeral 1006. In connection with transmission of the uplink data packet, the base station 106 can detect a CRC failure and can trigger (e.g., initiate) a HARQ retransmission to request that the device 108 retransmit the uplink data packet, as indicated at reference numeral 1008.

There can be a packet delay budget that can indicate an available amount of time for HARQ retransmission of the uplink data packet (e.g., in response to a CRC failure), such as described herein. In some embodiments, the CMC 112, employing the retransmission manager component 516, can adjust the packet delay budget for HARQ retransmission to the available packet delay budget 1010 to account for and mitigate uplink data packet delay to facilitate prioritizing HARQ retransmission of the uplink data packet and mitigate undesirable discarding of uplink data packets with regard to HARQ retransmission, such as described herein. The retransmission manager component 516 can determine an available packet delay budget 1010 as a function of the packet delay budget and the uplink data packet delay (e.g., the packet delay budget minus the uplink data packet delay). The available packet delay budget 1010 can indicate an available amount of time for HARQ retransmission of the uplink data packet if HARQ retransmission of the uplink data packet is desired (e.g., wanted, necessary, or initiated). In this example HARQ retransmission scenario 1000, the CMC 112, employing the scheduler component 508 and/or the retransmission manager component 516, also can prioritize HARQ retransmission of the uplink data packet, in accordance with the available packet delay budget 1010. For instance, the CMC 112, employing the scheduler component 508 and/or the retransmission manager component 516, can generate DCI, comprising uplink grant information relating to an uplink grant time, that can prioritize HARQ retransmission of the uplink data packet, in accordance with the available packet delay budget 1010.

As indicated at reference numeral 1012, in connection with the HARQ retransmission request, the base station 106 can communicate the DCI, comprising the uplink grant information, to the device 108, wherein such uplink grant information can indicate the time (e.g., another time slot during another frame associated with another SFN) that the prioritized HARQ retransmission of the uplink data packet can be performed by the device 108 to communicate the uplink data packet (e.g., the retransmitted uplink data packet) to the base station 106. The device 108 can receive this DCI within the available packet delay budget 1010.

Accordingly, in this example HARQ retransmission scenario 1000, since the CMC 112 is employing an enhanced available packet delay budget 1010 and has prioritized the HARQ retransmission of the uplink data packet, the device 108 can communicate (e.g., re-transmit) the uplink data packet (e.g., the retransmitted uplink data packet) to the base station 106 within the available packet delay budget 1010 (e.g., before the available packet delay budget 1010 expires), as indicated at reference numeral 1014. As a result, the uplink data packet is not undesirably discarded. This example HARQ retransmission scenario 1000 is in contrast to the example HARQ retransmission scenario 400 described with regard to FIG. 4 where, due in part to the undesirable uplink transmission delay associated with the initial transmission of the uplink data packet, the time of the uplink grant for the HARQ retransmission can be outside of the packet delay budget 402 (e.g., can be after the packet delay budget 402 has expired), and, as a result, the uplink data packet in the example HARQ retransmission scenario 400 can end up being undesirably discarded.

With further regard to the base station 106, the base station 106 can receive and transmit signal(s) from and to wireless devices like access points (e.g., base stations, femtocells, picocells, or other type of access point), access terminals (e.g., UEs), wireless ports and routers, and the like, through a set of antennas 569₁-569_{R}. In an aspect, the antennas 569₁-569_{R} can be a part of a communication platform 520, which comprises electronic components and associated circuitry that can provide for processing and manipulation of received signal(s) and signal(s) to be transmitted. In an aspect, the communication platform 520 can include a receiver/transmitter 522 that can convert signal from analog to digital upon reception, and from digital to analog upon transmission. In addition, receiver/transmitter 522 can divide a single data stream into multiple, parallel data streams, or perform the reciprocal operation.

In an aspect, coupled to receiver/transmitter 522 can be a multiplexer/demultiplexer (mux/demux) 524 that can facilitate manipulation of signal in time and frequency space. The mux/demux 524 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 524 can scramble and spread information (e.g., codes) according to substantially any code known in the art, e.g., Hadamard-Walsh codes, Baker codes, Kasami codes, polyphase codes, and so on. A modulator/demodulator (mod/demod) 526 also can be part of the communication platform 520, and can modulate information according to multiple modulation techniques, such as frequency modulation, amplitude modulation (e.g., M-ary quadrature amplitude modulation (QAM), with M a positive integer), phase-shift keying (PSK), and the like.

The base station 106 also can comprise a processor(s) 528 that can be configured to confer and/or facilitate providing functionality, at least partially, to substantially any electronic component in or associated with the base station 106. For instance, the processor(s) 528 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, etc.

In another aspect, the base station 106 can include a data store 530 that can store data structures; code instructions; rate coding information; information relating to measurement of radio link quality or reception of information related thereto; information relating to devices, uplink data packet delay, uplink grants, configured grants, uplink grant or data packet transmission scheduling, HARQ retransmissions, packet delay budget, available packet delay budget, DRBs, communication conditions (e.g., signal-to-interference-plus-noise ratio (SINR), reference signal received power (RSRP), reference signal received quality (RSRQ), channel quality indicator (CQI), and/or other wireless communications metrics or parameters) associated with devices, metadata, policies and rules, users, applications, services, communication management criteria, traffic flows, signaling, algorithms (e.g., communication management algorithm(s), uplink grant algorithm(s), configured grant algorithm(s), uplink grant scheduling algorithm(s), or other algorithm(s)), protocols, interfaces, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on. The processor(s) 528 can employ one or more processors (e.g., one or more central processing units (CPUs)), microprocessors, or controllers) that can process information, and can be coupled to the data store 530 in order to store and retrieve at least some of the information (e.g., information, such as algorithms, relating to multiplexing/demultiplexing or modulation/demodulation; information relating to radio link levels; information relating to devices, uplink data packet delay, uplink grants, configured grants, uplink grant or data packet transmission scheduling, HARQ retransmissions, packet delay budget, available packet delay budget, DRBs, communication conditions (e.g., SINR, RSRP, RSRQ, CQI, and/or other wireless communications metrics or parameters) associated with devices, metadata, communication devices, policies and rules, users, applications, services, communication management criteria, traffic flows, signaling, algorithms (e.g., communication management algorithm(s), uplink grant algorithm(s), configured grant algorithm(s), uplink grant scheduling algorithm(s), or other algorithm(s)), protocols, interfaces, tools, and/or other information) desired to operate and/or confer functionality to the communication platform 520 and/or other operational components of the base station 106.

The data store 530 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

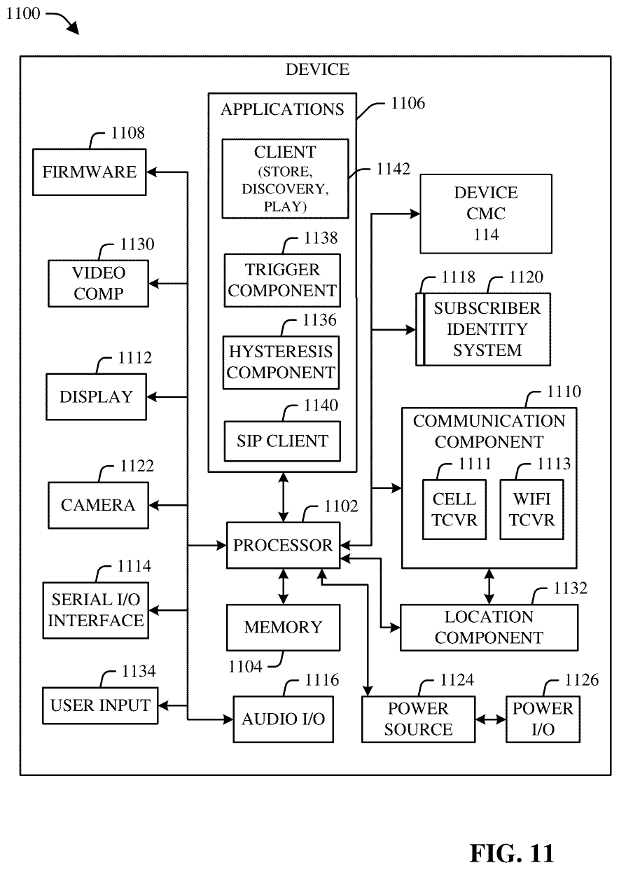

Turning now to FIG. 11, depicted is a block diagram of an example device 1100 (e.g., wireless or mobile phone, electronic pad or tablet, electronic eyewear, electronic watch, other electronic bodywear, IoT device, or other type of communication device), the device 1100 can be operable to engage in a system architecture that facilitates wireless communications according to one or more embodiments described herein. Although a device is illustrated herein, it will be understood that other devices can be a communication device, and that the device 108 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 1100, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 1100 can include a processor(s) 1102 for controlling and processing all onboard operations and functions. The processor(s) 1102 can comprise one or more processors (e.g., one or more central processing units (CPUs)), microprocessors, or controllers) that can process information associated with the device 1100. A memory 1104 can interface to the processor(s) 1102 for storage of data and one or more applications 1106 (e.g., a video player software, user feedback component software, etc.). Other applications can include voice recognition of predetermined voice commands that facilitate initiation of the user feedback signals. The applications 1106 can be stored in the memory 1104 and/or in a firmware 1108, and executed by the processor(s) 1102 from either or both the memory 1104 or/and the firmware 1108. The firmware 1108 can also store startup code for execution in initializing the device 1100. A communication component 1110 interfaces to the processor(s) 1102 to facilitate wired/wireless communication with external systems, e.g., cellular networks, VoIP networks, and so on. Here, the communication component 1110 can also include a suitable cellular transceiver 1111 (e.g., a global system for mobile communication (GSM), orthogonal frequency division multiple access (OFDMA), 4G, LTE, 5G, other NR, or other type of transceiver) and/or an unlicensed transceiver 1113 (e.g., Wi-Fi, WiMax) for corresponding signal communications. The device 1100 can be a device such as a cellular telephone, a PDA with mobile communications capabilities, and messaging-centric devices. The communication component 1110 also facilitates communications reception from terrestrial radio networks (e.g., broadcast), digital satellite radio networks, and Internet-based radio services networks.

The device 1100 includes a display 1112 for displaying text, images, video, telephony functions (e.g., a Caller ID function), setup functions, and for user input. For example, the display 1112 can also be referred to as a “screen” that can accommodate the presentation of multimedia content (e.g., music metadata, messages, wallpaper, graphics, etc.). The display 1112 can also display videos and can facilitate the generation, editing and sharing of video quotes. A serial I/O interface 1114 is provided in communication with the processor(s) 1102 to facilitate wired and/or wireless serial communications (e.g., USB, and/or IEEE 1394) through a hardwire connection, and other serial input devices (e.g., a keyboard, keypad, and mouse). This supports updating and troubleshooting the device 1100, for example. Audio capabilities are provided with an audio I/O component 1116, which can include a speaker for the output of audio signals related to, for example, indication that the user pressed the proper key or key combination to initiate the user feedback signal. The audio I/O component 1116 also facilitates the input of audio signals through a microphone to record data and/or telephony voice data, and for inputting voice signals for telephone conversations.

The device 1100 can include a slot interface 1118 for accommodating a SIC (Subscriber Identity Component) in the form factor of a card Subscriber Identity Module (SIM) or universal SIM 1120, and interfacing the SIM card 1120 with the processor(s) 1102. However, it is to be appreciated that the SIM card 1120 can be manufactured into the device 1100, and updated by downloading data and software.

The device 1100 can process IP data traffic through the communication component 1110 to accommodate IP traffic from an IP network such as, for example, the Internet, a corporate intranet, a home network, a person area network, etc., through an ISP or broadband cable provider. Thus, VoIP traffic can be utilized by the device 1100 and IP-based multimedia content can be received in either an encoded or a decoded format.

A video processing component 1122 (e.g., a camera) can be provided for decoding encoded multimedia content. The video processing component 1122 can aid in facilitating the generation, editing, and sharing of video quotes. The device 1100 also includes a power source 1124 in the form of batteries and/or an AC power subsystem, which power source 1124 can interface to an external power system or charging equipment (not shown) by a power I/O component 1126.

The device 1100 can also include a video component 1130 for processing video content received and, for recording and transmitting video content. For example, the video component 1130 can facilitate the generation, editing and sharing of video quotes. A location tracking component 1132 facilitates geographically locating the device 1100. As described hereinabove, this can occur when the user initiates the feedback signal automatically or manually. A user input component 1134 facilitates the user initiating the quality feedback signal. The user input component 1134 can also facilitate the generation, editing and sharing of video quotes. The user input component 1134 can include such conventional input device technologies such as a keypad, keyboard, mouse, stylus pen, and/or touch screen, for example.

Referring again to the applications 1106, a hysteresis component 1136 facilitates the analysis and processing of hysteresis data, which is utilized to determine when to associate with the access point. A software trigger component 1138 can be provided that facilitates triggering of the hysteresis component 1136 when the Wi-Fi transceiver 1113 detects the beacon of the access point. A SIP client 1140 enables the device 1100 to support SIP protocols and register the subscriber with the SIP registrar server. The applications 1106 can also include a client 1142 that provides at least the capability of discovery, play and store of multimedia content, for example, music.

The device 1100, as indicated above related to the communication component 1110, includes an indoor network radio transceiver 1113 (e.g., Wi-Fi transceiver). This function supports the indoor radio link, such as IEEE 802.11, for the dual-mode GSM device (e.g., device 1100). The device 1100 can accommodate at least satellite radio services through a device (e.g., handset device) that can combine wireless voice and digital radio chipsets into a single device (e.g., single handheld device).

In some embodiments, the device 1100 can comprise a device CMC 114 that, from the device side, can desirably (e.g., suitably, efficiently, enhancedly, or optimally) manage transmission of uplink data using configured grants or periodic uplink grants, and HARQ retransmission of uplink data packets, wherein undesirable (e.g., unwanted or inefficient) uplink data packet delay can be mitigated (e.g., reduced or minimized), and wherein undesirable discarding of uplink data packets for HARQ retransmission can be mitigated, such as described herein.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

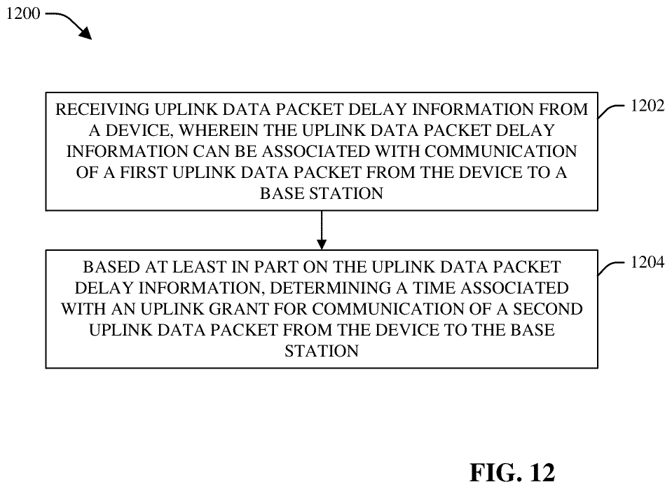

In view of the example systems and/or devices described herein, example methods that can be implemented in accordance with the disclosed subject matter can be further appreciated with reference to flowcharts in FIGS. 12-15. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 12 illustrates a flow chart of an example method 1200 that can desirably (e.g., efficiently, suitably, enhancedly, or optimally) manage and perform communication of uplink data associated with a device, with reduced uplink data packet delay, in accordance with various aspects and embodiments of the disclosed subject matter. The method 1200 can be employed by, for example, a system comprising the base station, which can comprise the CMC (e.g., can comprise the DU comprising the CMC), the processor component, the data store, and/or other components.

At 1202, uplink data packet delay information can be received from a device, wherein the uplink data packet delay information can be associated with communication of a first uplink data packet from the device to a base station. The DU of the base station can receive the uplink data packet delay information associated with communication of the first uplink data packet from the device (e.g., communication device) to the base station. The uplink data packet delay information can indicate an amount of communication delay for the first uplink data packet between a first time the first uplink data packet was generated or otherwise ready for transmission by the device to the base station and a second time of an uplink grant (e.g., configured grant or a periodic uplink grant) to communicate the first uplink data packet from the device to the base station, due at least in part to waiting for a time slot associated with the uplink grant.

At 1204, based at least in part on the uplink data packet delay information, a time associated with an uplink grant for communication of a second uplink data packet from the device to the base station can be determined. The CMC of the base station (e.g., the DU of the base station) can determine the time (e.g., a desirable time slot of a frame associated with an SFN) associated with the uplink grant for communication of the second uplink data packet from the device to the base station, based at least in part on the uplink data packet delay information, to facilitate mitigating (e.g., reducing or minimizing) an amount of delay for communication of the second uplink data packet from the device to the base station and/or to facilitate mitigating (e.g., reducing or minimizing the occurrence of) discarding of data packets, such as the second data packet, associated with HARQ retransmission. For instance, the CMC can determine the time associated with the uplink grant for communication of the second uplink data packet from the device to the base station based at least in part on the uplink data packet delay information, the previous uplink grant information (e.g., information relating to the time of the previous uplink grant) associated with the first uplink data packet, and/or a threshold jitter (e.g., threshold amount of jitter) for uplink grant, such as described herein.

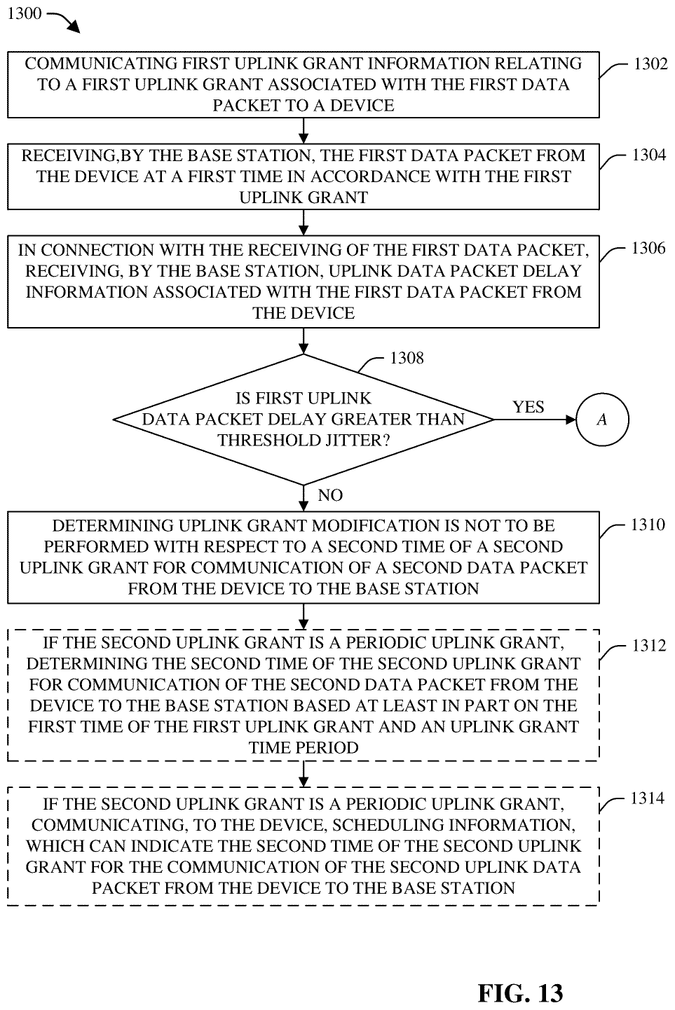

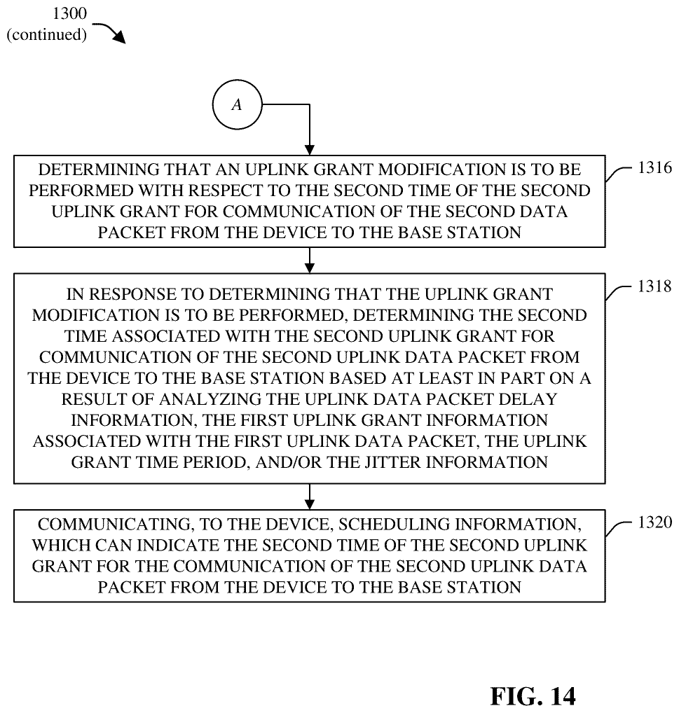

FIGS. 13 and 14 depict a flow chart of another example method 1300 that can desirably (e.g., efficiently, suitably, enhancedly, or optimally) manage and perform communication of uplink data associated with a device, with reduced uplink data packet delay, in accordance with various aspects and embodiments of the disclosed subject matter. The method 1300 can be employed by, for example, a system comprising the base station, which can comprise the CMC (e.g., can comprise the DU comprising the CMC), the processor component, the data store, and/or other components.

At 1302, first uplink grant information relating to a first uplink grant associated with the first data packet can be communicated to a device. The base station (e.g., the DU of the base station), employing, the CMC, can determine the first uplink grant information relating to the first uplink grant associated with the first data packet that is to be communicated by the device to the base station. In accordance with various embodiments, the first uplink grant can be a periodic uplink grant or a configured grant. The base station (e.g., the CMC of the DU of the base station) can communicate the first uplink grant information to the device. The device can receive the first uplink grant information from the base station.

At 1304, the first data packet can be received by the base station from the device at a first time in accordance with the first uplink grant. At 1306, in connection with the receiving of the first data packet, uplink data packet delay information associated with the first data packet can be received by the base station from the device, wherein the uplink data packet delay information can be associated with communication of the first uplink data packet from the device to the base station.

In some embodiments, the device, employing the device CMC, can determine (e.g., calculate) the first uplink data packet delay associated with the first data packet based at least in part on (e.g., as a function of) a time (e.g., packet availability time) that the first uplink data packet was generated or otherwise ready for transmission by the device (e.g., buffered in a buffer component or queue of the device) to the base station and the first time of the first uplink grant (e.g., configured grant or a periodic uplink grant) to communicate the first uplink data packet from the device to the base station, such as described herein. The first uplink data packet delay can indicate an amount of communication delay for the first uplink data packet between the time (e.g., packet availability time) that the first uplink data packet was generated or otherwise ready for transmission by the device to the base station and the first time of the first uplink grant to communicate the first uplink data packet from the device to the base station, due at least in part to waiting for a time slot associated with the first uplink grant. The device can communicate the uplink data packet delay information relating to (e.g., indicative of) the first uplink data packet delay with, or in connection with, the communication of the first data packet from the device to the base station, such as described herein.

The base station can receive the first data packet and/or the uplink data packet delay information from the device at the first time in accordance with the first uplink grant. For instance, using and in accordance with the first uplink grant information, the device can communicate the first data packet and/or the uplink data packet delay information at the first time (e.g., in a first time slot of a first SFN) to the base station.

At 1308, a determination can be made regarding whether the first uplink data packet delay associated with the communication of the first uplink packet from the device to the base station is greater than a defined threshold amount of jitter associated with uplink grants (e.g., the first uplink grant). The CMC can analyze (e.g., compare) the uplink data packet delay information indicative of the first uplink data packet delay and jitter information indicative of the defined threshold amount of jitter associated with uplink grants. Based at least in part on the results of analyzing the uplink data packet delay information and the jitter information, the CMC can determine whether the first uplink data packet delay is greater than the defined threshold amount of jitter.

If it is determined that the first uplink data packet delay is not greater than the defined threshold amount of jitter, at 1310, a determination can be made that an uplink grant modification is not to be performed with respect to a second time of a second uplink grant for communication of a second data packet from the device to the base station. If the CMC determines that the first uplink data packet delay is not greater than (e.g., is less than or equal to) the defined threshold amount of jitter, the CMC can determine that the uplink grant modification is not to be performed with respect to the second time (e.g., next uplink time slot or next configured grant time slot) of the second uplink grant (e.g., a next periodic uplink grant or next configured grant) for communication of the second data packet from the device to the base station.

In some embodiments, if the second uplink grant is a periodic uplink grant, at 1312, the second time of the second uplink grant for communication of the second data packet from the device to the base station can be determined based at least in part on the first time of the first uplink grant and an uplink grant time period. For instance, the CMC can determine (e.g., calculate) the second time of the second uplink grant for communication of the second data packet from the device to the base station based at least in part on (e.g., as a function of) the first time of the first uplink grant and the uplink grant time period (e.g., the first time (e.g., first time slot) of the first uplink grant plus the uplink grant time period (e.g., a number of time slots of a frame)), wherein the uplink grant time period can be set or determined based at least in part on an uplink grant periodicity (e.g., associated with the service or application).

In some embodiments, if the second uplink grant is a periodic uplink grant, at 1314, scheduling information, which can indicate the second time of the second uplink grant for the communication of the second uplink data packet from the device to the base station, can be communicated to the device. For instance, the CMC can communicate DCI, comprising the scheduling and/or uplink grant information, to the device. In response to receiving the DCI, and based at least in part on the DCI, the device can communicate the second uplink data packet from the device to the base station at the second time, in accordance with the second uplink grant and associated DCI and scheduling information.

In other embodiments, if the second uplink grant is a configured grant (e.g., which can be or can act as an implicit or automatic uplink grant, in accordance with the uplink grant periodicity), the CMC can determine that scheduling and/or reconfiguration information does not have to be communicated to the device, since there is no uplink grant modification (e.g., no reconfiguration of the configured grant) being performed at this time, and no scheduling and/or reconfiguration information is to be communicated to the device at this time. Accordingly, the device can communicate the second uplink data packet from the device to the base station at the second time (e.g., a particular second configured grant time slot of a second frame associated with a second SFN) that can correspond to (e.g., can be the same time slot number as) the first time (e.g., a particular first configured grant time slot of a first frame associated with a first SFN), in accordance with the configured grant (e.g., the previously implemented configured grant).

Referring again to reference numeral 1308, if, instead, at 1308, it is determined that the first uplink data packet delay is greater than the defined threshold amount of jitter, the method 1300 can proceed to reference point A, wherein the method 1300 can continue from reference point A to reference numeral 1316, and can proceed from that point, as depicted in FIG. 14. At 1316, a determination can be made that an uplink grant modification is to be performed with respect to the second time of the second uplink grant for communication of the second data packet from the device to the base station. If the CMC determines that the first uplink data packet delay is greater than the defined threshold amount of jitter, the CMC can determine that the uplink grant modification is to be performed with respect to the second time (e.g., next uplink time slot or next configured grant time slot) of the second uplink grant (e.g., next periodic uplink grant or next configured grant) for communication of the second data packet from the device to the base station.

At 1318, in response to determining that the uplink grant modification is to be performed, the second time associated with the second uplink grant for communication of the second uplink data packet from the device to the base station can be determined based at least in part on a result of analyzing the uplink data packet delay information, the first uplink grant information associated with the first uplink data packet, the uplink grant time period, and/or the jitter information. For instance, in response to the CMC determining that the uplink grant modification is to be performed, the CMC can determine (e.g., calculate) the second time associated with the second uplink grant for communication of the second uplink data packet from the device to the base station based at least in part on the result of analyzing the uplink data packet delay information, the first uplink grant information associated with the first uplink data packet, the uplink grant time period, and/or the jitter information (e.g., indicative of the defined threshold amount of jitter), such as described herein.

At 1320, scheduling information, which can indicate the second time of the second uplink grant for the communication of the second uplink data packet from the device to the base station, can be communicated to the device. For instance, the CMC can communicate DCI, comprising the scheduling information, to the device, to facilitate communication of the second uplink data packet from the device to the base station at the second time of the second uplink grant, in accordance with the scheduling information and associated second uplink grant.

In some embodiments, if the uplink data is being periodically communicated to the base station using the periodic uplink grant, the CMC can communicate the DCI, comprising the scheduling information, to the device. The device can receive the DCI, including the scheduling information. Based at least in part on (e.g., in accordance with) the scheduling information, the device can communicate the second uplink data packet to the base station at the second time of the second uplink grant.

In other embodiments, if the uplink data is being periodically communicated to the base station using the configured grant, the CMC can communicate the DCI, comprising the scheduling information, to the device, wherein the scheduling information can comprise reconfiguration information to facilitate reconfiguring the configured grant to have the device communicate the second uplink data packet to the base station at the second time (e.g., at the (re)configured grant time slot of the frame corresponding to the second time) and/or communicate a subsequent uplink data packet(s) to the base station at a subsequent time(s) (e.g., at the corresponding (re)configured grant time slot(s) of a subsequent frame(s)), in accordance with reconfigured grant. The device can receive the DCI, including the scheduling information. Based at least in part on (e.g., in accordance with) the scheduling information (e.g., the reconfiguration information of the scheduling information), the device (e.g., the device CMC of the device) can reconfigure the configured grant, in accordance with a configured grant timer configuration protocol, and can communicate the second uplink data packet to the base station at the second time of the second uplink grant, in accordance with the reconfigured grant. In certain embodiments, the CMC can schedule the communication of the DCI to the device at a desired amount of time (e.g., a desired number of time slots) prior to the second time of the second uplink grant, based at least in part on the reconfigured grant time slot and a defined time factor value (e.g., the reconfigured grant time slot minus the defined time factor value (e.g., k2)), such as described herein.

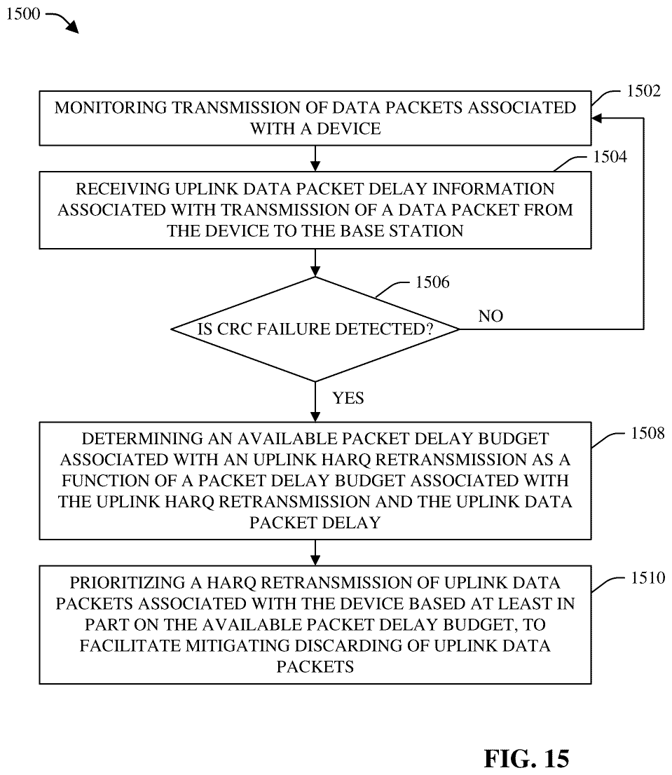

FIG. 15 illustrates a flow chart of an example method 1500 that can desirably (e.g., efficiently, suitably, enhancedly, or optimally) manage and perform communication of uplink data associated with a device, with reduced discarding of uplink data packets with regard to HARQ retransmission, in accordance with various aspects and embodiments of the disclosed subject matter. The method 1500 can be employed by, for example, a system comprising the base station, which can comprise the CMC (e.g., can comprise the DU comprising the CMC), the processor component, the data store, and/or other components.

At 1502, transmission of data packets associated with a device can be monitored. For instance, the CMC can monitor the transmission (e.g., uplink transmission) of the data packets associated with the device (e.g., from the device to the base station) to facilitate determining whether a CRC failure is detected.

At 1504, uplink data packet delay information associated with transmission of a data packet from the device to the base station can be received. The CMC can receive, from the device, the uplink data packet delay information associated with the transmission of the data packet from the device to the base station. The device can determine (e.g., calculate) the uplink data packet delay associated with the data packet, and generate the uplink data packet delay information, which can indicate or specify the uplink data packet delay, such as described herein.

At 1506, a determination can be made regarding whether a CRC failure has been detected with regard to the transmission of a data packet associated with the device. The CMC can analyze the data packets (e.g., transmitted data packets) and associated information (e.g., metadata, such as error detection bits or code) as part of performing a CRC process. Based at least in part on the results of such analysis and/or the performing of the CRC process, the CMC can determine whether a CRC failure has been detected with regard to the transmission of a data packet associated with the device.

If no CRC failure has been detected with regard to transmission of a data packet associated with the device, the method 1500 can return to reference numeral 1502, wherein the method 1500 can proceed to monitor the transmission of data packets associated with the device, and can continue from that point. For instance, if, based at least in part on the results of the analysis and/or the performing of the CRC process, the CMC determines that no CRC failure has been detected with regard to transmission of a data packet associated with the device, the CMC can continue to monitor the transmission of data packets associated with the device, and determine whether a CRC failure is detected.

If, instead, it is determined that a CRC failure has been detected with regard to transmission of a data packet associated with the device, at 1508, an available packet delay budget associated with an uplink HARQ retransmission can be determined as a function of a packet delay budget associated with the uplink HARQ retransmission and the uplink data packet delay. For instance, if the CMC determines that a CRC failure has been detected with regard to transmission of a data packet associated with the device, the CMC can determine (e.g., calculate) the available packet delay budget associated with the uplink HARQ retransmission as a function of the packet delay budget associated with the uplink HARQ retransmission and the amount of the uplink data packet delay (e.g., available packet delay budget equals packet delay budget minus the uplink data packet delay), such as described herein.

At 1510, a HARQ retransmission of uplink data packets associated with the device can be prioritized based at least in part on the available packet delay budget, to facilitate mitigating discarding of uplink data packets. The CMC can prioritize the HARQ retransmission of the uplink data packets based at least in part on the available packet delay budget, to facilitate mitigating (e.g., reducing or minimizing) discarding of uplink data packets. For instance, the CMC can prioritize the HARQ retransmission of the uplink data packets utilizing the smallest value of the available packet delay budget. This prioritization of HARQ retransmission of uplink data packets can ensure that HARQ retransmission of uplink data packets associated with the device are still attempted within the packet delay budget.

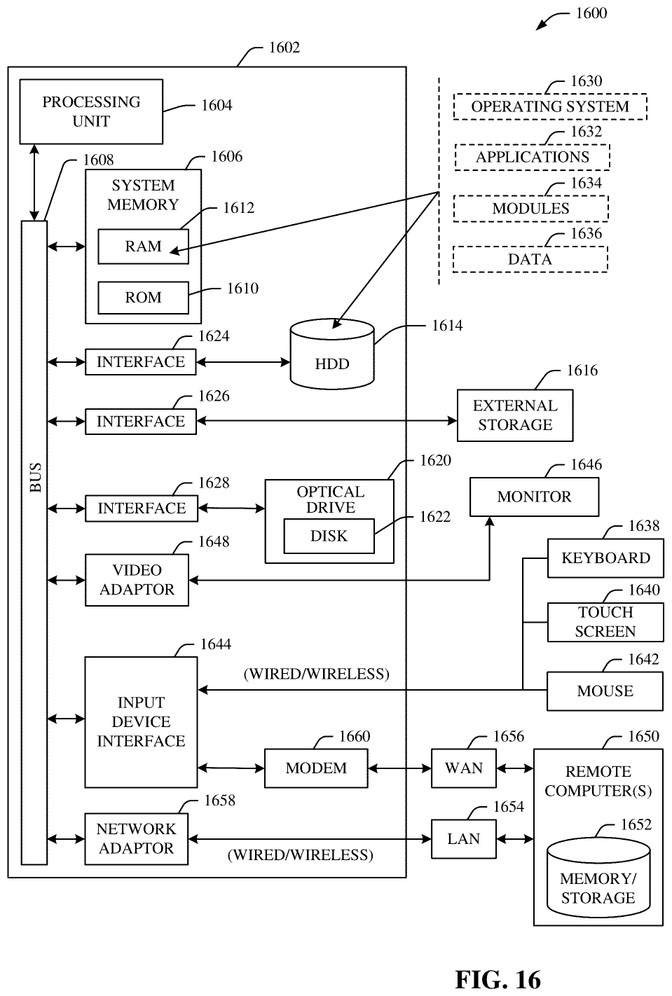

In order to provide additional context for various embodiments described herein, FIG. 16 and the following discussion are intended to provide a brief, general description of a suitable computing environment 1600 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are examples and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656, e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A device or communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), Internet of things (IoT) device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, user equipment (UE), communication network, core network, service, application, base station, distributed unit (DU), central unit (CU)-user plane (UP) (CU-UP) node, central unit (CU)-control plane (CP) (CU-CP) node, communication manager component (CMC), device CMC, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
receiving, by a system comprising a processor, from a device, uplink data packet delay information associated with a first communication of a first uplink data packet from the device to a base station; and
based on the uplink data packet delay information, determining, by the system, a time associated with an uplink grant for a second communication of a second uplink data packet from the device to the base station.

2. The method of claim 1, wherein the determining of the time associated with the uplink grant, based on the uplink data packet delay information, mitigates an amount of time delay for the second communication of the second uplink data packet by the device.

3. The method of claim 2, wherein the uplink grant is a second uplink grant, wherein the time is a second grant time, wherein the determining of the second grant time associated with the second uplink grant based on the uplink data packet delay information results in the second uplink grant being scheduled or configured at a time slot of a frame associated with a system frame number that is closer to a generation time of generation, or a buffering time of buffering, of the second uplink data packet than a different time slot of the frame that otherwise would have been scheduled or configured for the second uplink grant absent the determining of the second grant time associated with the second uplink grant based on the uplink data packet delay information,
wherein the uplink data packet delay indicates an uplink data packet delay associated with the first communication of the first uplink data packet, and wherein the uplink data packet delay is determined based on the generation time and a first grant time of a first uplink grant to perform the first communication of the first uplink data packet or based on the buffering time and the first grant time.

4. The method of claim 1, wherein the uplink grant is a periodic uplink grant that is associated with a periodicity associated with the uplink grant, wherein the uplink grant is a second uplink grant, wherein the time is a second time, and wherein the determining of the time for the uplink grant comprises:
determining the second time associated with the second uplink grant for the second communication of the second uplink data packet by the device, based on analyzing of the uplink data packet delay information relating to a first amount of delay associated with the first communication of the first uplink data packet, a first time of a first uplink grant for the first communication of the first uplink data packet, an uplink grant time period, or jitter information relating a second amount of jitter associated with communication of uplink data packets.

5. The method of claim 4, wherein the determining of the second time associated with the second uplink grant comprises:
in response to determining that the first amount of delay is greater than the second amount of jitter, determining the second time associated with the second uplink grant as a function of the first amount of delay, the first time of the first uplink grant, the uplink grant time period, and the second amount of jitter.

6. The method of claim 4, wherein the determining of the second time associated with the second uplink grant comprises:
in response to determining that the first amount of delay is less than or equal to the second amount of jitter, determining the second time associated with the second uplink grant as a function of the first time of the first uplink grant and the uplink grant time period.

7. The method of claim 4, wherein the uplink data packet delay information is first uplink data packet delay information, and wherein the method further comprises:
in response to determining that second uplink data packet delay information associated with the second communication of the second uplink data packet from the device to the base station has not been received, determining a third time associated with a third uplink grant for a third communication of a third uplink data packet from the device to the base station as a function of the second time of the second uplink grant and the uplink grant time period.

8. The method of claim 1, wherein the uplink grant is a second configured grant that is associated with a periodicity associated with the second uplink grant, wherein the time is a second time, and wherein the determining of the time associated with the uplink grant comprises:
determining the second time associated with the second configured grant for the second communication of the second uplink data packet by the device, based on analyzing of the uplink data packet delay information relating to a first amount of delay associated with the first communication of the first uplink data packet, a first time of a first configured grant associated with the first communication of the first uplink data packet, an uplink grant time period, or jitter information relating a second amount of jitter associated with communication of uplink data packets.

9. The method of claim 8, wherein the determining of the second time associated with the second configured grant comprises:
in response to determining that the first amount of delay is greater than the second amount of jitter, determining the second time associated with the second configured grant as a function of the first amount of delay, the first time of the first configured grant, the uplink grant time period, and the second amount of jitter.

10. The method of claim 8, wherein the determining of the second time associated with the second configured grant comprises:
in response to determining that the first amount of delay is less than or equal to the second amount of jitter, determining that the second configured grant is not to be reconfigured relative to the first configured grant, wherein the second time associated with the second configured grant is associated with a second time slot in a second frame that corresponds to a first time slot in a first frame associated with the first time.

11. The method of claim 1, wherein the uplink grant is a periodic uplink grant or a configured grant, and wherein the method further comprises:
based on the uplink data packet delay information, determining, by the system, that the periodic uplink grant or the configured grant is to be modified;
one of:
with regard to the periodic uplink grant, scheduling, by the system, the uplink grant based on the determining of the time associated with the uplink grant, or
with regard to the configured grant, initiating, by the system, reconfiguring of a configured grant time slot to a reconfigured configured grant time slot that is to be utilized for the second communication of the second uplink data packet based on the determining of the time associated with the uplink grant; and
communicating, by the system, to the device, scheduling information relating to the scheduling of the periodic uplink grant, or reconfiguration information relating to the reconfiguring of the configured grant time slot to the reconfigured configured grant time slot, to facilitate the second communication of the second uplink data packet at the time associated with the uplink grant in accordance with the scheduling of the periodic uplink grant or the reconfiguring of the configured grant time slot.

12. The method of claim 11, further comprising:
with regard to the configured grant, based on the reconfigured configured grant time slot and a defined time factor value, determining, by the system, a downlink-control-information time to schedule communication of downlink control information, comprising the reconfiguration information, to the device; and
communicating, by the system, the downlink control information to the device in accordance with the downlink-control-information time.

13. The method of claim 1, further comprising:
in response to detecting a cyclic redundancy check failure associated with communication of data packets from the device to the base station, determining, by the system, an available packet delay budget associated with an uplink hybrid-automatic-repeat-request retransmission as a function of a packet delay budget associated with the uplink hybrid-automatic-repeat-request retransmission and an amount of an uplink data packet delay, wherein the amount of the uplink data packet delay is determined based on the uplink data packet delay information; and
prioritizing, by the system, the uplink hybrid-automatic-repeat-request retransmission of the second data packet based on the available packet delay budget, to facilitate mitigating discarding of uplink data packets.

14. The method of claim 1, wherein the first uplink data packet or the second uplink data packet is a delay sensitive data packet relating to a factory automation service, a process automation service, an autonomous or semi-autonomous vehicle-related service, a law enforcement-related service, an emergency-related service, a military-related service, or a smart grid-related service.

15. A system, comprising:
a memory that stores computer executable components; and
a processor that executes computer executable components stored in the memory, wherein the computer executable components comprise:
a distributed unit that receives, from user equipment, uplink data delay information associated with a first transmission of first uplink data from the user equipment to a base station; and
a communication manager component that, based on analysis of the uplink data delay information, determines a time of an uplink grant for a second transmission of second uplink data from the user equipment to the base station.

16. The system of claim 15, wherein the uplink grant is a second uplink grant, wherein the second uplink grant is a second periodic uplink grant or a second configured grant that is associated with a periodicity associated with the second uplink grant, wherein the time is a second time,
wherein the communication manager component determines the second time of the second uplink grant, based on a result of analyzing the uplink data delay information relating to a first amount of delay associated with the first transmission of the first uplink data, a first time of a first uplink grant for the first transmission of the first uplink data, an uplink grant time period, or jitter information relating a second amount of jitter associated with transmission of uplink data, and
wherein the first uplink grant is a first periodic uplink grant or a first configured grant that is associated with the periodicity associated with the first uplink grant or the second uplink grant.

17. The system of claim 16, wherein, in response to determining that the first amount of delay is greater than the second amount of jitter, the communication manager component determines the second time of the second uplink grant based the first amount of delay, the first time associated with the first uplink grant, the uplink grant time period, and the second amount of jitter.

18. The system of claim 16, wherein, in response to determining that the first amount of delay is less than or equal to the second amount of jitter, the communication manager component determines the second time of the second uplink grant based on the first time of the first uplink grant and the uplink grant time period; or
wherein the uplink data delay information is first uplink data delay information, and wherein, in response to determining that second uplink data delay information associated with the second transmission of the second uplink data from the user equipment to the base station has not been received by the distributed unit, the communication manager component determines a third time of a third uplink grant for a third transmission of third uplink data from the user equipment to the base station based on the second time of the second uplink grant and the uplink grant time period.

19. A non-transitory machine-readable medium, comprising executable instructions that, when executed by a processor, facilitate performance of operations, comprising:
receiving, from a device, uplink data packet delay information associated with a first communication of a first uplink data packet from the device to network equipment; and
based on the uplink data packet delay information, determining a time slot of a frame associated with an uplink grant for a second communication of a second uplink data packet from the device to the network equipment.

20. The non-transitory machine-readable medium of claim 19, wherein the uplink grant is a second uplink grant, wherein the second uplink grant is a periodic uplink grant or a configured grant that is associated with a periodicity associated with the second uplink grant, wherein the time slot of the frame is a second time slot of a second frame, and wherein the determining of the time slot of the frame associated with the uplink grant comprises: determining the second time slot of the second frame associated with the second uplink grant for the second communication of the second uplink data packet by the device, based on a result of analyzing the uplink data packet delay information relating to a first amount of delay associated with the first communication of the first uplink data packet, a first time slot of a first frame associated with a first uplink grant for the first communication of the first uplink data packet, an uplink grant time period, or jitter information relating a second amount of jitter associated with communication of uplink data packets.
